(19) United States
(12) Patent Application Publication
(10) Pub. No.: US 2013/0205944 A1
(43) Pub. Date: Aug. 15, 2013

(54) Torque Transmission Assembly, In Particular Hydrodynamic Torque Converter, Fluid Coupling Or Wet-Running Clutch

(71) Applicants: Jörg Sudau, Niederwerrn (DE); Armin Stürmer, Rannungen (DE); Rüdiger Lotze, Schweinfurt (DE); Thomas Krüger, Berlin (DE); Christoph Drott, Grossostheim (DE)

(72) Inventors: Jörg Sudau, Niederwerrn (DE); Armin Stürmer, Rannungen (DE); Rüdiger Lotze, Schweinfurt (DE); Thomas Krüger, Berlin (DE); Christoph Drott, Grossostheim (DE)

(73) Assignee: ZF Friedrichshafen AG, Friedrichshafen (DE)

(21) Appl. No.: 13/696,756

(22) PCT Filed: Mar. 31, 2011
(86) PCT No.: PCT/EP11/55013

§ 371 Date: Jan. 10, 2013

(30) Foreign Application Priority Data
May 7, 2010 (DE) 10 2010 028 735.0

(51) Int. Cl. F16F 7/10

(52) U.S. Cl. CPC F16F 7/1034
USPC 74/573.1

(57) ABSTRACT

A torque transmission assembly, particularly a hydrodynamic torque converter, a fluid coupling or a wet clutch, includes a housing arrangement that includes a torsional vibration damper arrangement having an input region which is coupled to or can be coupled to the housing arrangement and an output region to be coupled to a driven member. The torque transmission assembly also includes at least one mass damper arrangement having a damper mass arrangement which is coupled to the torque transmission assembly by a mass damper elastic arrangement.

### CROSS REFERENCE TO RELATED APPLICATIONS

This is a U.S. national stage of application No. PCT/DE2011/055013, filed on 31 March 2011. Priority is claimed on German Application No. 10 2010 028735.0, filed 7 May 2010, the content of which is incorporated here by reference.

### BACKGROUND OF THE INVENTION

1. Field of the Invention

The present invention is directed to a torque transmission assembly which is constructed, for example, in the form of a hydrodynamic torque converter, a fluid coupling or a wet clutch.

2. Description of the Prior Art

Torque transmission assemblies of the type mentioned above are used in the drivetrain of vehicles to transmit torque between a drive unit, for example, an internal combustion engine, and a downstream region of a drivetrain, for example, a transmission. Various vibratory excitations occur in a drivetrain of this kind which can be triggered, for instance, by the ignition frequency of an internal combustion engine and which are thus related to the rotational speed thereof. Torsional vibration damper arrangements which generally have a primary side and a secondary side as well as a damper spring arrangement acting therebetween are used to eliminate such vibratory excitations or rotational irregularities in the drivetrain as far as possible. It has been shown that a sufficient decoupling of vibrations cannot be ensured, particularly in the lower speed range, e.g., less than 1000 RPM, by torsional vibration damper arrangements of this kind which can also include two or more torsional vibration damper units working in series.

So-called speed-adaptive mass dampers are also not effectively decoupling to a sufficient degree in the lower speed range because of the comparatively low kinetic energy. Speed-adaptive mass dampers comprise vibration masses which are movable in circumferential direction along guide paths. The guide paths generally have a radius of curvature that is less than their maximum distance from the axis of rotation. Accordingly, a circumferential deflection of these vibration masses takes place in centrifugal potential and counter to the centrifugal force outwardly impinging thereon. Therefore, speed-adaptive mass dampers are primarily characterized in that they have an amplitude reduction proportional to the rotational speed so that they can be tuned to a certain excitation order, but are nevertheless insufficiently effective in the low speed range.

### SUMMARY OF THE INVENTION

It is therefore an object of the present invention to provide a torque transmission assembly, particularly a hydrodynamic torque converter, fluid coupling or wet clutch, by which an improved vibration damping characteristic can be achieved above all in the lower speed range.

According to the invention, a torque transmission assembly, particularly a hydrodynamic torque converter, fluid coupling or wet clutch, includes a housing arrangement, within which are provided a torsional vibration damper arrangement having an input region which is coupled to or can be coupled to the housing arrangement and an output region to be coupled to a driven member. The torque transmission assembly further includes at least one mass damper arrangement having a damper mass arrangement which is coupled to the torque transmission assembly by means of a mass damper elastic arrangement.

One or more mass damper arrangements designed on the principle of a fixed-frequency mass damper is/are used in the torque transmission assembly according to the invention. The selection of the mass of the damper mass arrangement on the one hand and of the stiffness of the mass damper elastic arrangement on the other hand makes it possible to tune to a predefined excitation frequency so that vibratory excitations occurring particularly in the range of lower rotational speeds can be eliminated more efficiently.

It can be provided, for example, that the mass damper elastic arrangement comprises an elastomer material arrangement, for which rubber or rubber-like materials have proven advantageous owing to their excellent durability.

In an alternative embodiment, the mass damper elastic arrangement can comprise a spring arrangement, preferably a helical spring arrangement. The use of a mass damper elastic arrangement of this kind which is generally formed of metal is particularly advantageous when this mass damper elastic arrangement is arranged in the interior of the housing arrangement and is therefore also exposed over the operating lifetime to fluid, e.g., oil, which is generally contained in a housing arrangement of this kind.

The at least one mass damper arrangement can be coupled to the housing arrangement, which also allows this mass damper arrangement to be positioned outside of the housing. In this case, the mass damper arrangement does not take up any installation space inside the housing.

In another embodiment, at least one mass damper arrangement is coupled to the torsional vibration damper arrangement. This at least one mass damper arrangement is accordingly located in the interior of the housing arrangement, but can be integrated in a vibratory system by coupling together with the torsional vibration damper arrangement so that tuning to determined excitation frequencies is improved.

For example, at least one mass damper arrangement can be coupled to the input region of the torsional vibration damper arrangement and/or to the output region thereof.

In another embodiment which is advantageous with respect to the installation space occupied, the torsional vibration damper arrangement comprises a torsional vibration damper unit with a primary side and a secondary side which is rotatable with respect to the primary side around an axis of rotation against the action of a damper spring arrangement, wherein the input region of the torsional vibration damper arrangement comprises the primary side and the output region of the torsional vibration damper arrangement comprises the secondary side. Accordingly, in this case the torsional vibration damper arrangement comprises only one individual torsional vibration damper unit.

To improve tuning to the rotational irregularities occurring in a drivetrain, the torsional vibration damper arrangement comprises a plurality of torsional vibration damper units working in series, wherein each torsional vibration damper unit comprises a primary side and a secondary side which is rotatable with respect to the primary side around an axis of rotation against the action of a damper spring arrangement. The input region of the torsional vibration damper arrangement comprises the primary side of a first torsional vibration damper unit of the torsional vibration damper units, the output side of the torsional vibration damper arrangement comprises the secondary side of a last torsional vibration damper unit of the torsional vibration damper units, and the secondary side of a preceding torsional vibration damper unit of two successively arranged torsional vibration damper units and the primary side of a following torsional vibration damper unit of two successively arranged torsional vibration damper units provide at least part of an intermediate mass arrangement.

In particular, when the torsional vibration damper arrangement comprises a plurality of torsional vibration damper units working in series and having intermediate mass arrangements arranged therebetween, at least one mass damper arrangement is coupled to an intermediate mass arrangement.

In a particularly advantageous alternative embodiment, the torque transmission assembly can have an impeller which is generally provided by, or at, the housing arrangement and a turbine arranged in the housing arrangement.

In order to achieve a merging of functions and therefore also a reduction in the required structural component parts in an embodiment of the kind mentioned above, the turbine is configured to provide at least part of the damper mass arrangement.

The turbine can be coupled to the input region or output region of the torsional vibration damper. Further, when configured with a plurality of torsional vibration damper units working in series, the turbine can also be coupled to an intermediate mass arrangement, which has proven particularly advantageous with respect to vibration damping.

The turbine and the mass damper arrangement can be coupled to the same intermediate mass arrangement. Further, at least one mass damper arrangement is coupled to the turbine and therefore, via the turbine, to the torsional vibration damper arrangement, i.e., either to the input region or to the output region or possibly an intermediate mass arrangement thereof.

In an alternative embodiment, it is suggested that the intermediate mass arrangement to which the turbine is coupled does not carry a mass damper arrangement.

In another embodiment of the torque transmission assembly according to the present invention the ratio of a mass moment of inertia MTM_{T} of the mass damper arrangement, particularly of the damper mass arrangement, to a mass moment of inertia MTM_{W} of the torque transmission assembly without a mass damper arrangement is:

0.1≦MTM_{T}/MTM_{W}≦0.5.

Moreover, a friction moment M_{R} of the mass damper arrangement, particularly of the mass damper elastic arrangement is:

M_{R}(n≦n_{G})≦7 Nm

M_{R}(n>n_{G})≧4 Nm,

where n is the rotational speed of the torque transmission assembly around the axis of rotation and n_{G} is a limiting rotational speed at a predetermined speed distance above a rotational speed corresponding to the natural frequency of the mass damper arrangement.

The friction moment in this case primarily addresses the structural component parts supported at the mass damper elastic arrangement by Coulomb friction of components of the mass damper arrangement, particularly springs of the mass damper elastic arrangement. It can be ensured through the selection of the friction moment in the indicated range that the occurring friction up to the limiting rotational speed is not great enough to impede oscillation of the damper mass arrangement. However, when the limiting rotational speed is reached or exceeded, the friction is so great that free oscillation of the damper mass arrangement is no longer possible in practice and the latter then substantially only acts as an additional mass.

Further, a ratio of an axial width b_{KRL} of a fluid circuit formed with the turbine and impeller to the radial height h_{KRL} of the fluid circuit is:

0.2≦b_{KRL}/h_{KRL}≦1.2.

It can be ensured through the selection of this ratio in the indicated range that sufficient installation space can be provided in the interior of the housing for providing a mass damper arrangement.

A ratio of a diameter Ø_{TF} of springs of the mass damper elastic arrangement to their radial distance RFN_{TF} with respect to the axis of rotation is:

0.1Ø_{TF}/RFN_{TF}≦0.33.

In a further embodiment, a ratio of a radial distance RFN of springs of the mass damper arrangement with respect to the axis of rotation to the radial distance r of a centroid of a mass part of the damper mass arrangement with respect to the axis of rotation is:

0.59≦RFN_{TF}/r_{TM}≦1.69.

The present invention is further directed to a drive system comprising a multi-cylinder internal combustion engine and a torque transmission assembly according to the present invention which is coupled with a crankshaft of the multi-cylinder internal combustion engine.

In a drive system of this kind, it can be provided, for example, that the ratio of a mass moment of inertia MTM_{T} of the mass damper arrangement, particularly of the damper mass arrangement, to the quantity n_{ZYL} of cylinders of the multi-cylinder internal combustion engine is:

0.0033 kgm²≦MTM_{T}/n_{ZYL}≦0.1 kgm².

Further a ratio of a stiffness C_{TF} of the mass damper elastic arrangement to the quantity n_{ZYL} of cylinders of the multi-cylinder internal combustion engine is:

0.92 Nm/°≦C_{TF}/n_{ZYL}≦12 Nm/°.

In a further embodiment, of the rotational speed of the multi-cylinder internal combustion engine corresponding to a natural frequency of the mass damper arrangement to the quantity n_{ZYL} of cylinders of the multi-cylinder internal combustion engine is:

100/min≦n_{EF}/n_{ZYL}≦1200/min.

In a four-cylinder internal combustion engine, for example, the four ignitions occur in the cylinders per two revolutions of the crankshaft. This means that at a rotational speed of 1000 revolutions per minute a mass damper arrangement with a natural frequency of 2000 RPM is excited to vibration in the range of its natural frequency.

### BRIEF DESCRIPTION OF THE DRAWINGS

For the purpose of further explanation of the invention, reference is made below to the following figures, in which:

FIGS. 1 to 6 are schematic diagrams of different alternatives of a torque transmission assembly with a turbine, a mass damper arrangement and a torsional vibration damper arrangement with one torsional vibration damper unit;

FIGS. 7 to 18 are schematic diagrams of different alternatives of a torque transmission assembly with a turbine, a mass damper arrangement and a torsional vibration damper arrangement with two torsional vibration damper units;

FIGS. 19 to 38 are schematic diagrams of different alternatives of a torque transmission assembly with a turbine, a mass damper arrangement and a torsional vibration damper arrangement with three torsional vibration damper units;

FIG. 39 is a schematic diagram of a torque transmission assembly with a mass damper arrangement arranged on the outer side thereof;

FIG. 40 is a partial longitudinal sectional view through a torque transmission assembly according to FIG. 5;

FIG. 41 is a partial longitudinal sectional view through a torque transmission assembly according to FIG. 7;

FIG. 42 is a partial longitudinal sectional view through a torque transmission assembly according to FIG. 9;

FIG. 43 is a partial longitudinal sectional view through a torque transmission assembly according to FIG. 15;

FIGS. 44 to 52 are partial longitudinal sectional views through a torque transmission assembly according to FIG. 17;

FIG. 53 and

FIG. 54 are partial longitudinal sectional views through a torque transmission assembly according to FIG. 5;

FIG. 55 is partial longitudinal sectional view of a torque transmission assembly in the form of a wet clutch arrangement with a mass damper arrangement arranged in the housing arrangement;

FIGS. 56 to 60 are partial longitudinal sectional views through a torque transmission assembly according to FIG. 39;

FIG. 61 is a table showing different quantities or ratios of quantities which can be realized in a torque transmission assembly;

FIG. 62 is a table showing a key for the quantities shown in FIG. 61; and

FIG. 63 is an illustration of a torque transmission assembly corresponding to FIG. 44 which graphically depicts different quantities contained in the tables in FIGS. 61 and 62.

### DETAILED DESCRIPTION OF THE PREFERRED EMBODIMENTS

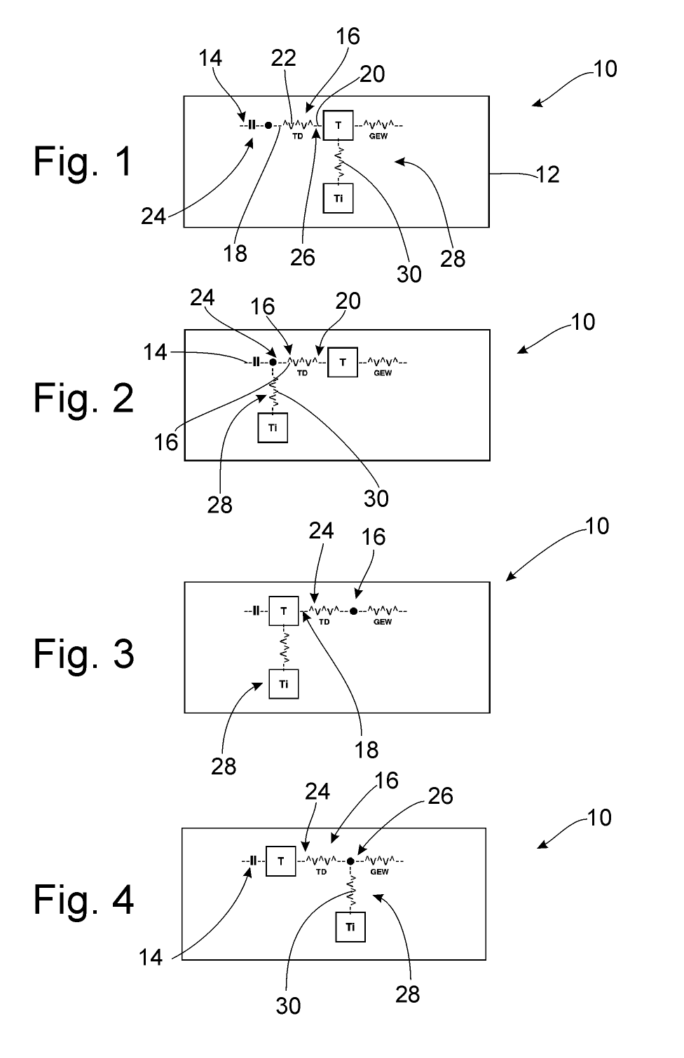

FIG. 1 is a schematic diagram showing a torque transmission assembly 10, e.g., in the form of a hydrodynamic torque converter. A turbine T is arranged in a housing 12, shown only schematically, into which a transmission input shaft GEW extends and which at the same time also provides or carries an impeller. This turbine T is coupled to the transmission input shaft GEW for transmission of torque. The turbine T and therefore the transmission input shaft GEW can be coupled directly, i.e., circumventing the fluid circuit, to the housing 12 via a lockup clutch 14 and a torsional vibration damper arrangement 16 in lockup mode.

In this construction, the torsional vibration damper arrangement 16 includes an individual torsional vibration damper unit TD with a primary side 18, a secondary side 20 and a damper spring arrangement 22 acting therebetween. In general this damper spring arrangement includes a plurality of damper springs, for example, helical compression springs, which are arranged successively in a circumferential direction and/or nested one inside the other. In principle, however, the damper spring arrangement can also have springs of a different type, for example, gas springs or spring elements provided by deformable, elastic blocks of material or the like. Since the torsional vibration damper arrangement 16 comprises only the individual torsional vibration damper unit TD, its primary side 18 substantially also provides an input region 24 of the torsional vibration damper arrangement. The secondary side 20 of the torsional vibration damper unit TD substantially also provides an output region 26 of the torsional vibration damper arrangement 16. The input region 24 can be coupled to the housing 12 via the lockup clutch 14. The output region 26 is connected to the turbine T for rotation in common around an axis of rotation, not shown in FIG. 1.

It is to be noted in this connection that, within the meaning of the present invention, the expressions “input region” and “output region” mean a selected assignment to different function groups which corresponds to the torque flow in the drive condition. In this condition, a torque is introduced by a drive unit, for example, an internal combustion engine, via the housing 12 and conveyed to the output region 26 and turbine T via the input region 24 in the lockup mode. Of course, in the coasting condition, for example, in the engine braking condition, the flow of torque runs in the reverse direction, is received by the transmission input shaft via the output region 26, conveyed to the input region 24 and transmitted via the lockup clutch 14 to the housing 12 and, therefore, the drive unit.

Also shown in FIG. 1 is a mass damper arrangement 28 with a damper mass arrangement Ti and a mass damper elastic arrangement 30 permitting an oscillation of the damper mass arrangement Ti. In the construction shown in FIG. 1, the mass damper arrangement 28 with its mass damper elastic arrangement 30 formed, for example, by a spring arrangement, preferably a plurality of helical compression springs, is coupled to the turbine T or secondary side 20 of the torsional vibration damper unit TD and therefore also to the output region 26 of the torsional vibration damper arrangement 16.

In this embodiment, vibrations and rotational irregularities occurring in the drivetrain can be damped or reduced directly at that region to which the transmission input shaft GEW is coupled. Accordingly, a comparatively small decoupling potential is demanded of the mass damper arrangement 28, which permits a compact construction.

As was described above with respect to FIG. 1, a mass damper arrangement 28, i.e., a mass damper arrangement with a damper mass arrangement Ti not positioned in the torque flow and a mass damper elastic arrangement 30, for example, in a form of a spring arrangement, which is likewise not positioned in the torque flow, is constructed as a fixed-frequency mass damper and accordingly makes it possible to configure to a critical excitation frequency, for example, in a speed range below 1000 RPM.

A modification of the torque transmission assembly 10 is shown in FIG. 2. Structural component parts and component assemblies which correspond to component assemblies already mentioned above with respect to construction or functionality are also designated by identical reference numerals in the modifications discussed in the following. Further, only the changed aspects relevant to the respective modifications will be addressed in the following.

In FIG. 2, with the turbine T coupled to the output region 20 of the torsional vibration damper arrangement 16, the mass damper arrangement 28 with its mass damper spring arrangement 30 is coupled to the input region 24 of the torsional vibration damper arrangement 16, i.e., therefore to the primary side 18 of the torsional vibration damper unit TD. Accordingly, the mass damper arrangement 30 is situated in the torque flow—with respect to the drive condition—without being directly coupled into the torque flow, i.e., without a torque being transmitted via the mass damper arrangement 28, directly downstream of the lockup clutch 14. During excitations above the natural frequency of the mass damper arrangement 28, the latter acts as additional mass, which improves the adjustability of the lockup clutch 14 in this speed range or excitation frequency range. Further, the risk of the damper mass arrangement Ti striking against end stops provided for this purpose is reduced.

In the variant of the torque transmission assembly 10 shown in FIG. 3, the turbine T is coupled to the input region 24 of the torsional vibration damper arrangement 16. The mass damper arrangement 28 is also coupled to this input region 24, i.e., the primary side 18 of the torsional vibration damper unit TD. As in the illustration shown in FIG. 1, this connection can be carried out directly or via the turbine T. With respect to the efficiency of the mass damper arrangement 28, this variant has the same advantages that were described above with reference to FIG. 3. By shifting the turbine T to the input region 24, the primary-side mass of the torsional vibration damper unit TD is increased. In the embodiments shown in FIGS. 2 and 3, a higher damping potential is required compared to the example shown in FIG. 1 owing to the fact that the connection is carried out substantially directly to the drive shaft, a drive unit, i.e., for example, a crankshaft, without the intermediary of substantial additional elasticity.

FIG. 4 shows an arrangement in which, with turbine T coupled to the input region 24 of the torsional vibration damper arrangement 16, the mass damper arrangement 28 is coupled to the output region 26 of the torsional vibration damper arrangement 16 by its mass damper spring arrangement 30. An advantage of this variant is that the mass damper arrangement 28 acts as a simple secondary-side mass in the supercritical range of the torsional vibration damper arrangement 16, i.e., at rotational speeds or vibratory excitations lying above the natural frequency of the torsional vibration damper arrangement 16.

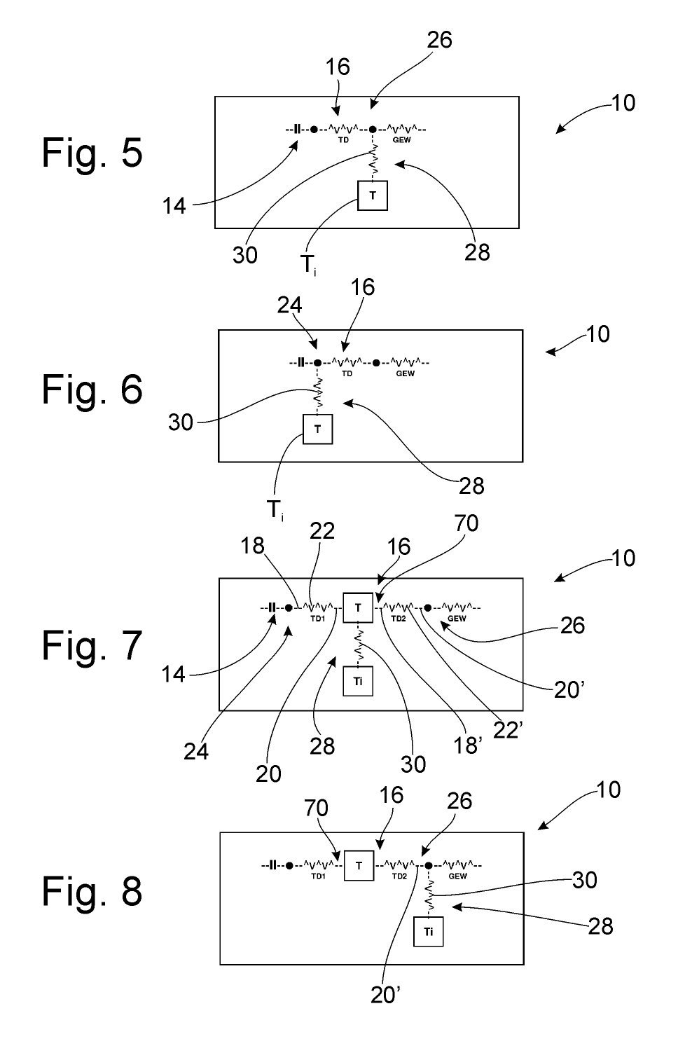

FIG. 5 shows an embodiment in which the mass damper arrangement 28 is coupled to the output region 26 of the torsional vibration damper arrangement 16. In this embodiment, the damper mass arrangement Ti is substantially provided by the turbine T. This means that there is only an installation space requirement for providing the mass damper elastic arrangement 30. Because of the use of the turbine T for this purpose, the damper mass arrangement Ti is neutral with respect to installation space.

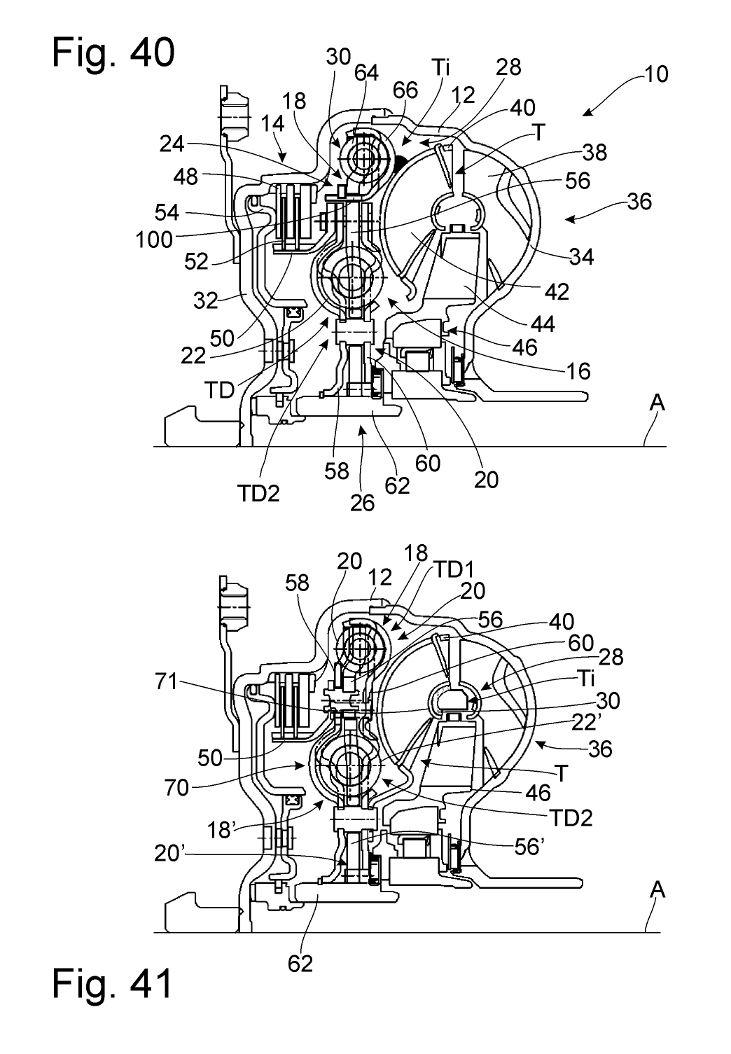

An embodiment of the torque transmission assembly 10 shown in FIG. 5 is illustrated in FIG. 40. Depicted is the housing 12 with its drive-side housing shell 32 and its driven-side housing shell 34 which simultaneously also provides an impeller shell for an impeller 36 which is accordingly integrated in the housing 12. The impeller blades 38 are supported at the inner side of this housing shell 34 successively in a circumferential direction. The turbine T with its turbine shell 40 and turbine blades 42 supported thereon is arranged in the interior of the housing 12. The stator blades 44 of a stator, designated generally by 46, are situated between the radially inner region of the turbine blades 42 and the impeller blades 38.

The lockup clutch 14 comprises a plurality of friction elements or disks 48 coupled with the housing 12 and a plurality of friction elements or disks 52 coupled with an inner disk carrier 50. The latter can be pressed against one another by a clutch piston 54 to produce the lockup condition.

The torsional vibration damper arrangement 16 or torsional vibration damper unit TD thereof comprises as primary side 18 two cover disk elements 58, 60 which are constructed, for example, from a sheet metal material and which are fixedly connected to the inner disk carrier 50 by a plurality of rivet bolts and accordingly also provide a substantial component part of the input region 24. The secondary side 20 of the torsional vibration damper unit to which substantially also provides the output region 26 of the torsional vibration damper arrangement 16 comprises a central disk element 56. Circumferential supporting regions for the damper springs of the damper spring arrangement 22 are formed at the central disk element 56 on one hand and at the cover disk elements 58, 60 on the other hand. The primary side 18 and the secondary side 20 can rotate relative to one another around the axis of rotation A against the action of these circumferential supporting regions.

The central disk element 56 is coupled by tooth-like engagement to a driven hub 62 which can in turn be coupled to the transmission input shaft so as to be fixed with respect to rotation relative to it.

In its radially outer region, the central disk element 56 provides a plurality of circumferential supporting regions for springs 64, preferably helical compression springs, of the mass damper elastic arrangement 30 which are disposed successively in a circumferential direction. A cover disk-like coupling element 66 likewise provides circumferential supporting regions for the springs 64 of the mass damper elastic arrangement 30 and is also movable with respect to the central disk element 56 around the axis of rotation A accompanied by compression of the springs 64 of the mass damper elastic arrangement 30 in the manner of a vibration damper arrangement or can execute a circumferential oscillation.

The coupling element 66 is fixedly connected to the turbine shell 40 of the turbine T by welding and accordingly forms substantially together with the latter the damper mass arrangement Ti of the mass damper arrangement 28. Through the connection of the damper mass arrangement Ti to the central disk element 56 through of the springs 64, i.e., the mass damper elastic arrangement 30, a connection to the secondary side 26 of the torsional vibration damper unit TD is carried out at the same time. Since the driving torque must be conducted via the mass damper arrangement 28 in the converter operating mode, this mass damper arrangement 28 acts substantially as a torsional vibration damper unit in converter mode in series with the following torsional vibration damper unit TD. That is a mass damper function is essentially not exercised. However, the springs 64 of the mass damper elastic arrangement 30 are designed in such a way that they can transmit the driving torque or the converted driving torque. On the other hand, the stops 100 of the mass damper elastic arrangement 30 absorb and convey the residual torque which is to be transmitted but which cannot be transmitted by the mass damper elastic arrangement 30. In the lockup condition, i.e., when the lockup clutch is engaged, virtually no torque is transmitted via the turbine T so that the mass damper arrangement 28 with its damper mass arrangement Ti can then act as such, i.e., is not connected into the torque transmission path.

In this embodiment, the turbine T itself is not centered so that the centering in axial and radial directions is carried out substantially via the mass damper elastic arrangement 30, i.e., the springs 64 or coupling element 66 and the central disk element 56. Of course, the turbine shell 40 could also be guided farther radially inward and be supported at that location axially and/or radially, e.g., on the driven hub 62.

Although the damper mass arrangement Ti in this embodiment will have a small total mass because of the comparatively light construction of the turbine T, the turbine T with its turbine shell 42 moves in the oil filling the housing 12 when vibratory excitations occur, which affects the natural frequency of the mass damper arrangement 28.

FIG. 6 shows a schematic diagram of an embodiment of the torque transmission assembly 10 in which the turbine T, which substantially also provides the damper mass arrangement Ti, is coupled to the input region 24 of the torsional vibration damper arrangement 16 via the mass damper elastic arrangement 30. In this case also, additional installation space for a damper mass which would otherwise have to be provided is saved. In converter mode and during operation at excitation over the natural frequency or damper frequency of the mass damper arrangement 28, the torsional vibration damper arrangement 16 acts as a turbine damper.

In the embodiments described above with reference to FIGS. 1 to 6, the torsional vibration damper arrangement comprises an individual torsional vibration damper unit. In the embodiments described below, the torsional vibration damper arrangement has two torsional vibration damper units.

Accordingly, FIG. 7 shows an embodiment example of the torque transmission assembly 10 in which a first torsional vibration damper unit TF1 is coupled by its primary side 18 to the lockup clutch 14 and therefore substantially also to the input region 24 of the torsional vibration damper arrangement 16. The secondary side 20 of the first torsional vibration damper unit TD 1 is rotatable with respect to the primary side 18 by its damper spring arrangement 22. Further, the secondary side 20 of the first torsional vibration damper unit TD1 is connected to a primary side 18′ of a second torsional vibration damper unit TD2 acting in series and, along with the latter, provides an intermediate mass arrangement 70. A secondary side 20′ of the second torsional vibration damper arrangement TD2 is coupled to the transmission input shaft GEW and substantially also provides the output region 26 of the torsional vibration damper arrangement 16. The primary side 18′ and the secondary side 20′ are rotatable with respect to one another around the axis of rotation against the action of the damper spring arrangement 22′ of the second torsional vibration damper unit TD2.

In the embodiment shown in FIG. 7, the turbine T is coupled to the intermediate mass arrangement 70 and substantially forms a part of the mass thereof. In the lockup condition, the two torsional vibration damper units TD 1 and TD2 work in series with one another. In the torque converter condition, i.e., the condition in which a torque is transmitted substantially via the turbine T, only the torsional vibration damper TD2 acts as turbine damper.

The mass damper arrangement 28 is coupled by its mass damper elastic arrangement 30 to the intermediate mass arrangement 70 either parallel to the turbine T or, for example, also via the turbine T.

In a speed range in which there is no vibratory excitation with the natural frequency or damper frequency of the mass damper arrangement 28, this increases the mass of the intermediate mass arrangement 70, which advantageously affects the vibration damping behavior.

FIG. 41 shows a construction of the arrangement shown schematically in FIG. 7. In this embodiment, the central disk element 56 is fixedly connected in its radially inner region to the inner disk carrier 50 and therefore substantially forms the primary side 18 of the torsional vibration damper unit TD 1. The radially outer region of the two cover disk elements 58, 60 substantially provides the secondary side 20 of torsional vibration damper unit TD1 which is rotatable with respect to the primary side 18 against the action of the damper spring arrangement 20, i.e., for example, a plurality of helical compression springs disposed successively in circumferential direction.

The radially inner region of the two cover disk elements 58, 60 also substantially forms the primary side 18′ of the second torsional vibration damper unit TD2 which is arranged and works in series with, and is positioned radially inside of, the first torsional vibration damper unit TD1. Another central disk element 56′ substantially forms the secondary side 20′ of the torsional vibration damper unit TD2 and is rotatable with respect to the primary side 18′ against the action of the damper spring arrangement 22′. The central disk element 56 is coupled to the driven hub 62 on the radially inner side.

The turbine shell 40 of the turbine T is drawn farther radially inward in this instance and is connected by rivet bolts to the cover disk elements 58, 60 which also substantially provide the intermediate mass arrangement 70. Accordingly, the turbine T contributes to the increased mass of the intermediate mass arrangement 70 and therefore also forms a component part thereof.

The mass damper arrangement 28 is arranged in the annular channel-shaped volume region between the turbine T, impeller 36, and stator 46. Mass damper arrangement 28 includes a damper mass arrangement Ti which extends in an annular or segment-shaped manner in a circumferential direction around the axis of rotation A and which is connected to the turbine T, particularly an inner turbine shell 71, via the mass damper elastic arrangement 30. The mass damper elastic arrangement 30 is formed in this instance with elastomer material, for example, rubber or rubber-like material, and allows a circumferential relative oscillation between the turbine T and the damper mass arrangement Ti.

A particular advantage of this embodiment is that no additional installation space need be reserved for the mass damper arrangement 28. Further, the arrangement of the mass damper arrangement 28 in the indicated volume region improves the circulation behavior of the fluid circuit in the hydrodynamic torque converter. In particular, flow losses on both sides of the stator 46 are low.

FIG. 8 shows a schematic diagram of another embodiment of the torque transmission assembly 10. It will be seen that the turbine T is again positioned between the two torsional vibration damper units TD 1 and TD2 of the torsional vibration damper arrangement 16. The mass damper arrangement 28 is coupled by its mass damper elastic arrangement 30 to the output region 26 of the torsional vibration damper arrangement 16 and therefore to the secondary side 20′ of the second torsional vibration damper unit TD2. Accordingly, the mass damper arrangement 28 acts directly in front of the transmission input shaft GEW so that the damping potential of the two torsional vibration damper units TD 1 and TD2 can be utilized in an optimal manner. The mass damper arrangement 28 acts as an additional mass in an excitation frequency range above the natural frequency of the mass damper arrangement 28. Further, by introducing a friction force, it is possible to deactivate the mass damper arrangement 28, i.e., to prevent an oscillation of the damper mass arrangement Ti, so as only to make use of the increased mass in other operating conditions as well. Of course, this embodiments also applies to the other embodiments which have already been described above and to the embodiments described below.

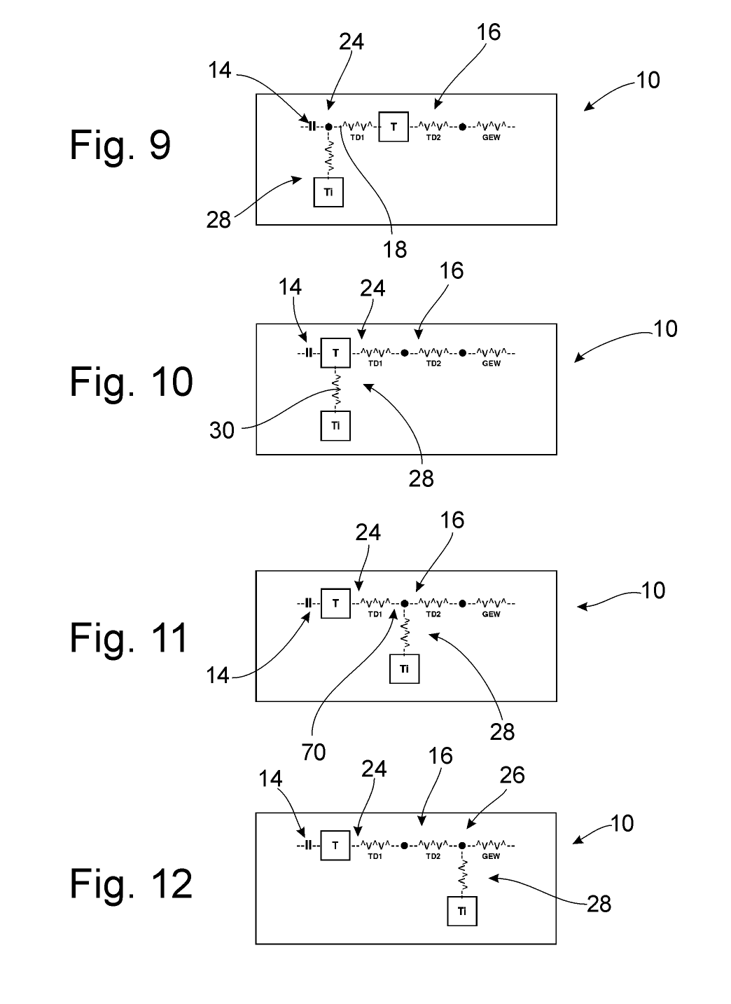

In the embodiment of the torque transmission assembly 10 shown in FIG. 9, the mass damper arrangement 28 is coupled to the input region 24 of the torsional vibration damper arrangement 16 and therefore to the primary side 18 of the first torsional vibration damper unit TD1 immediately downstream of the lockup clutch 14.

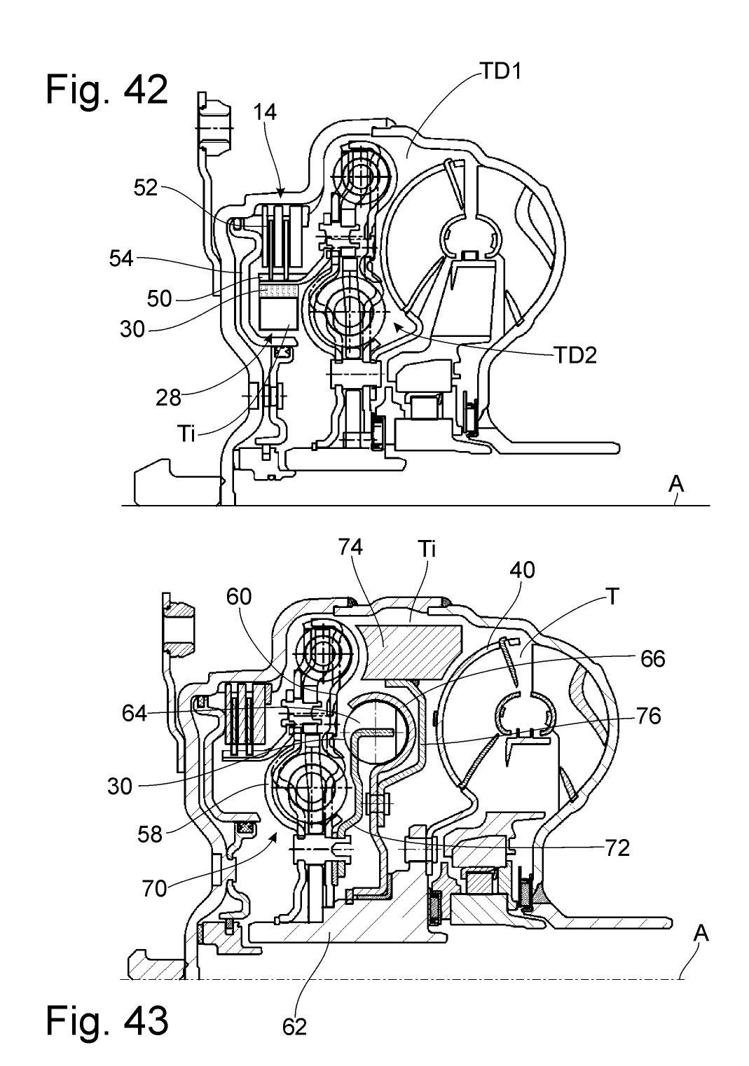

An embodiment thereof is shown in FIG. 42. It will be seen that the mass damper arrangement 28 is coupled to the inner circumferential region of the inner disk carrier 50. This mass damper arrangement 28 comprises a damper mass arrangement Ti which extends in an annular or annular segment-shaped manner around the axis of rotation A and which is connected to the inner disk carrier 50 via the mass damper elastic arrangement 30. In this case also, the mass damper elastic arrangement 30 is preferably formed of elastomer material. An advantage of this variant consists in the low installation space requirement, because the space available radially inside of the inner disk carrier 50 in the region in which the latter supports the friction elements 52 can be utilized.

FIG. 10 shows an embodiment of the torque transmission assembly 10 in which the turbine T is coupled to the input region 24 of the torsional vibration damper arrangement 16. The mass damper arrangement 28 is likewise coupled to the input region 24, for example, parallel to the turbine, or, as is shown, via the turbine T. In a frequency range above the damper frequency or natural frequency of the mass damper arrangement 28, this mass damper arrangement 28 acts to increase the primary-side mass of the torsional vibration damper unit TD 1. This improves the adjustability of the lockup clutch 14 in this frequency range and speed range. Since the turbine T is located in the torque flow upstream of the two torsional vibration damper units TD1 and TD2, its damping potential can be made use of to the full extent in converter mode. Owing to the arrangement of the elastic devices, this solution is of particularly interest in case of a relatively soft transmission input shaft.

In the embodiment shown in FIG. 11 with turbine T further coupled to the input region 24, the mass damper arrangement 28 is coupled to the intermediate mass arrangement 70 between the two torsional vibration damper units TD1 and TD2. This means that the mass damper arrangement 28 contributes to the increased mass of the intermediate mass arrangement 70 in the frequency range above its natural frequency.

FIG. 12 shows the turbine T coupled to the input region 24 of the torsional vibration damper arrangement 16, while the mass damper arrangement 28 is coupled to the output region 26. In this case, the mass damper arrangement 28 is accordingly again arranged directly in front of the transmission input shaft GEW, which permits a very efficient use of the damping potential of the two torsional vibration damper units TD1 and TD2 acting in series. The mass damper arrangement 28 contributes to the increased mass at the output region 26 above the natural frequency of the mass damper arrangement 28. The positioning of the turbine T at the input region 24, i.e., directly adjoining the lockup clutch 14, results in advantages with respect to adjustment when actuating the lockup clutch 14.

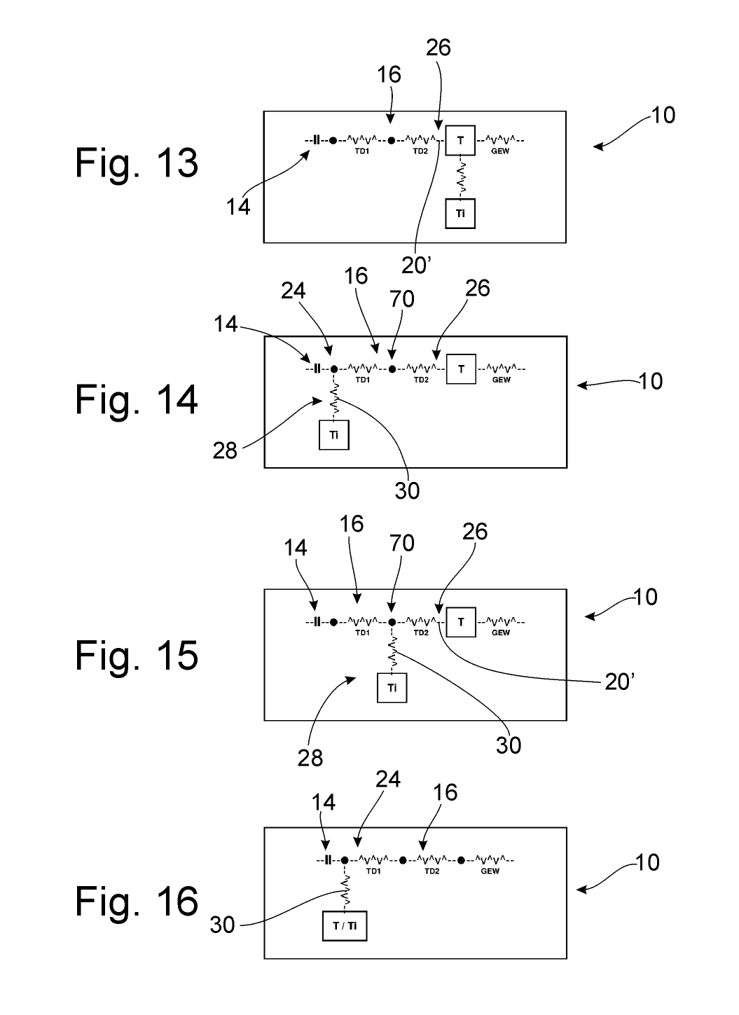

FIG. 13 shows an embodiment in which the turbine T is coupled to the output region 26 of the torsional vibration damper arrangement 16 and, therefore, to the secondary side 20′ of the second torsional vibration damper unit TD2. This embodiment is particularly suitable in drivetrains with comparatively torsionally stiff transmission input shafts. Also, in this embodiment the damping potential of the two torsional vibration damper units TD1 and TD2 working in series can be used in an efficient manner.

FIG. 14 shows an embodiment in which the turbine T is coupled to the output region 26 of the torsional vibration damper arrangement 16, while the mass damper arrangement 28 is coupled to the input region 24 thereof. The adjustability of the lockup clutch 14 is improved in that the mass damper arrangement 28 contributes to increasing the inert mass at the input region 24 above the natural frequency of the mass damper arrangement 28. Further, the positioning of the turbine T at the output region 26 permits the functionality of a dual-mass flywheel to be provided.

In the embodiment shown in FIG. 15, the mass damper arrangement 28 is coupled to the intermediate mass arrangement 70 between the two torsional vibration damper units TD1 and TD2. The turbine is coupled to the output region 26 of the torsional vibration damper arrangement 16 and therefore to the secondary side 20′ of the torsional vibration damper unit TD2. A dual-mass flywheel functionality can be realized again by positioning the turbine T at the output region 26. It is a further advantage that the torque is not to be transmitted via stops of the mass damper arrangement 28 or of another torsional vibration damper unit in the startup condition. Outside of the damper frequency or natural frequency of the mass damper arrangement 28, the latter acts to increase the mass of the intermediate mass arrangement 70.

In the embodiment of FIG. 43, the turbine T is connected by its turbine shell 40 radially inwardly at the driven hub 62. A coupling element 72 is fixedly connected to the two cover disk elements 58, 60 which substantially provide the intermediate mass arrangement 70, for example, by rivet bolts which also fixedly connect the two cover disk elements 58, 60 to one another in the radially inner region. This coupling element 72 provides circumferential supporting regions for the springs 64 of the mass damper elastic arrangement 30. The additional coupling element 66 provides corresponding circumferential supporting regions and is supported radially inwardly axially and radially at the driven hub 62 so as to be rotatable with respect to the latter.

The damper mass arrangement Ti includes one or more mass parts 74 surrounding the axis of rotation A in an annular or segment-like manner, these mass parts 74 being connected to the coupling element 66 by one or more connection elements 76. The damper mass arrangement Ti accordingly substantially comprises the mass part or mass parts 74, the connection element or connection elements 76, and the coupling element 66 and, accompanied by compression of the springs 64, can oscillate in a circumferential direction with respect to the coupling element 72 and therefore with respect to the intermediate mass arrangement 70. The welding of sheet metal component parts which are generally nitrided can be avoided by connecting the connection element or connection elements 76 to the coupling element 66 by a rivet connection. Further, owing to the fact that most of the damper mass arrangement Ti, i.e., substantially the mass parts 74, is arranged comparatively far radially outward, a high damping potential is achieved.

FIG. 16 shows an embodiment in which the damper mass arrangement Ti includes the turbine T and is connected to the input region 24 of the torsional vibration damper arrangement 16 via the mass damper elastic arrangement 30. The damper mass arrangement Ti and the turbine T are accordingly substantially rigidly connected to one another in this case, which is advantageous with respect to the installation space occupied. The mass damper elastic arrangement 30 is to be configured in such a way that the torque transmitted over the turbine T can be received and conveyed further in the converter mode.

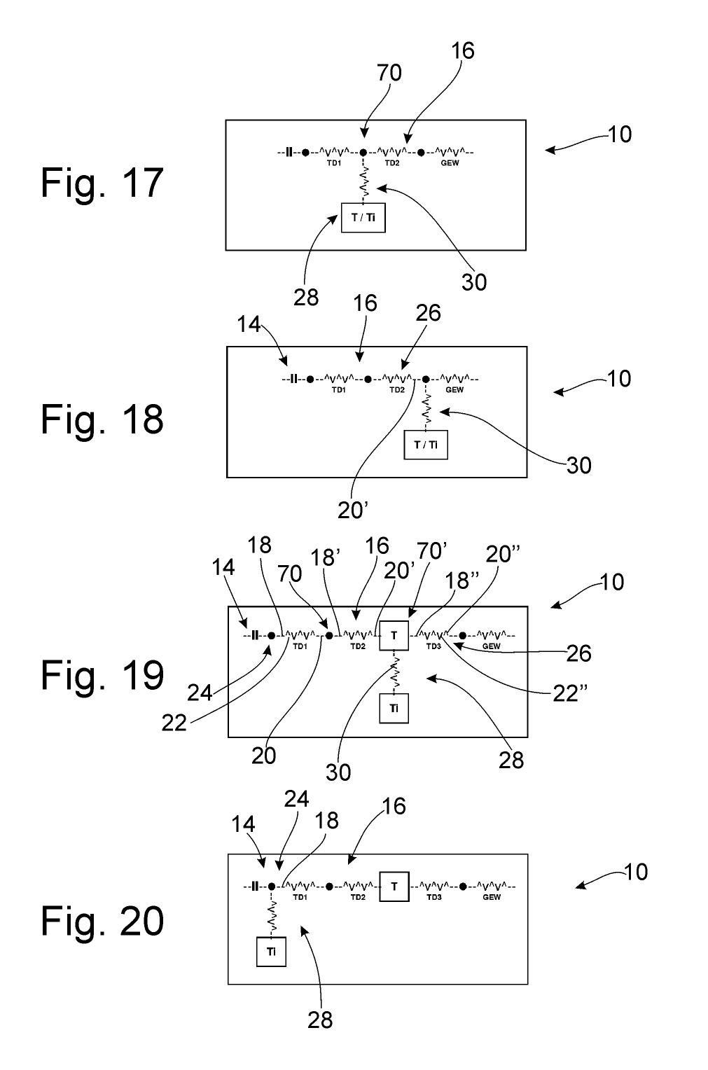

FIG. 17 shows an embodiment in which the damper mass arrangement Ti is connected along with the turbine T to the intermediate mass arrangement 70 between the two torsional vibration damper units TD1 and TD2 via the mass damper elastic arrangement 30. In this case also, the merging of functions results in an advantage with respect to installation space. Another advantage is the increased mass of the intermediate mass arrangement 70. In a frequency range outside the natural frequency of the mass damper arrangement 28, this mass damper arrangement 28 acts only as an additional mass.

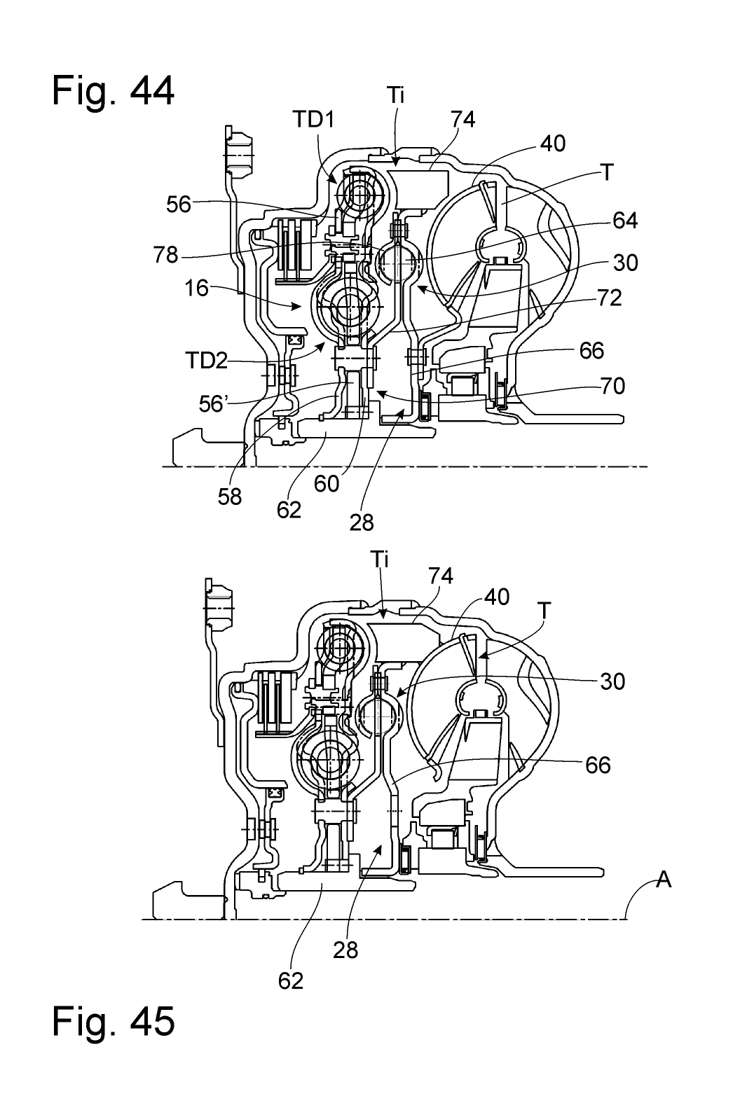

In the embodiment of FIG. 44, the two radially staggered torsional vibration damper units TD1 and TD2 working in series are shown. The two cover disk elements 58, 60 substantially form the intermediate mass region 70 of the torsional vibration damper arrangement 16. The coupling element 72 which provides circumferential supporting regions for the springs 64 of the mass damper elastic arrangement 30 in its radially outer region is connected, for example, riveted, to the intermediate mass arrangement 70 farther radially inward. The coupling element 66 which is axially and/or radially supported at the driven hub 62 carries, e.g., by means of riveting, the turbine T at its turbine shell 40 and likewise forms circumferential supporting regions for the springs 64 of the mass damper elastic arrangement 30. To this end, for example, the coupling element 66 together with another coupling element 78 fastened thereto by riveting can define a volume region surrounding the springs 64 of the mass damper elastic arrangement 30. Farther radially outward, a mass part 74 or a plurality of mass parts 74 is or are connected, e.g., welded, to the coupling element 66 so that the damper mass arrangement Ti includes mass part 74, coupling element 66 with additional coupling element 78, and turbine T.

A modification thereof is shown in FIG. 45. It will be seen that the turbine T is not connected to the coupling element 66 radially inwardly by riveting, but rather is connected in its radially outer region or in a radially outer region of the turbine shell 40 to the mass part 74 or mass parts 74 of the damper mass arrangement Ti by welding. As in the preceding embodiment in FIG. 44, the turbine T is supported by the mass part 66 with respect to the driven hub 62 and, therefore, the axis of rotation A. It will be seen that the installation space occupied radially outwardly by the mass part 74 is enlarged, which contributes to the increase in mass of the damper mass arrangement Ti.

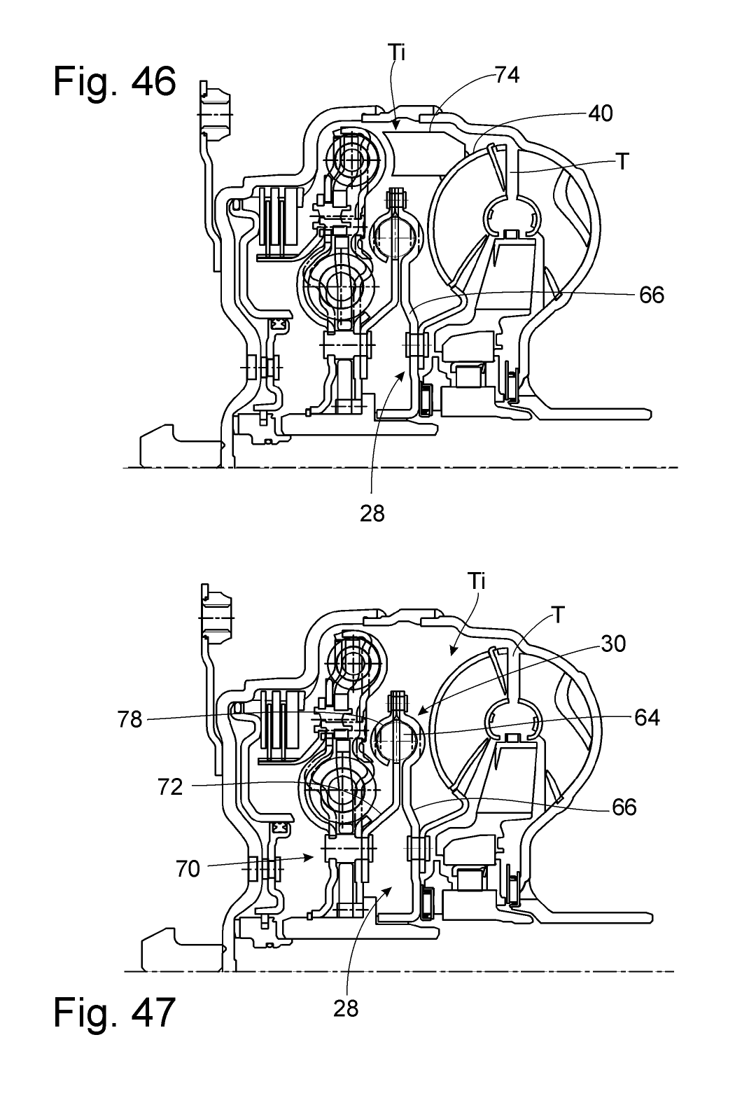

FIG. 46 shows am embodiment in which the mass part 74 or, as the case may be, a plurality of mass parts 74 are connected radially outwardly to the turbine shell 40 of the turbine T by welding. Turbine T carries the mass part or mass parts 74 of the damper mass arrangement Ti through its connection farther radially inward to the coupling element 66. This circumvents a weld connection between the mass part 74 and a coupling element which is generally formed as nitrided sheet metal part. Together with the mass part 74 which is situated far on the radially outer side, the turbine T contributes to a comparatively large mass of the damper mass arrangement Ti.

In the arrangement shown in FIG. 47, compared to the embodiment according to FIG. 46, there are no additional structural component parts, i.e., no mass parts 74, increasing the mass. The damper mass arrangement Ti of the mass damper arrangement 28 is provided in this case substantially by the turbine T and the coupling element 66. This makes it possible to position the springs 64, i.e., the mass damper elastic arrangement 30, farther radially outward so that a greater spring volume can be provided. Further, by shifting the springs 64 farther radially outward, the centrifugal force acting on the latter and, therefore, the friction force occurring particularly at the coupling elements 66 and 78, is increased. This means that when a limiting rotational speed is reached the friction can be so high that the damper function is no longer performed, i.e., the damper mass arrangement Ti will essentially no longer oscillate freely with respect to the intermediate mass arrangement 70 and contributes to the increase in the intermediate mass arrangement 70. The negatively acting vibratory excitation of the damper does not take place due to the friction.

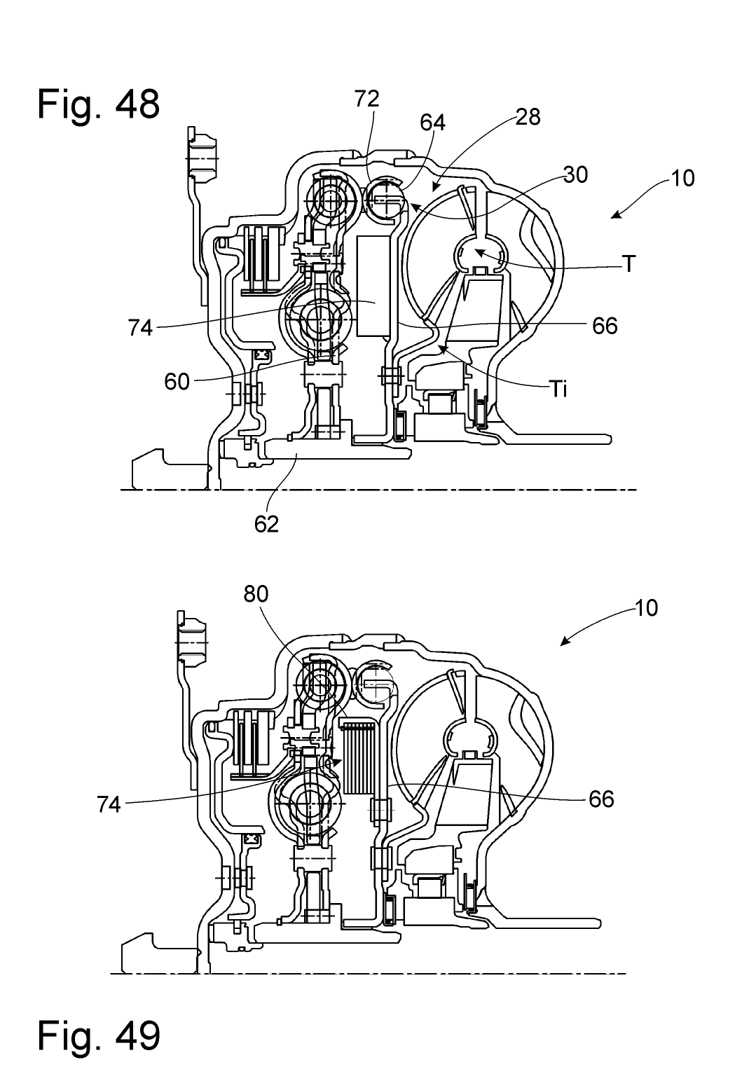

In the embodiment of the torque transmission assembly 10 shown in FIG. 48, the coupling element 72 serving to connect the mass damper arrangement 28 is constructed in such a way that it surrounds the springs 64 of the mass damper elastic arrangement 30 along the circumference thereof. Further, this coupling element 72 is connected to the radially outer region of the cover disk element 60, for example, by welding or riveting. The coupling element 66 extends radially inwardly and is axially and/or radially supported on the driven hub 62. In its radially central region, the coupling element 66 carries one or more mass parts 74 disposed successively in circumferential direction and together therewith and with the turbine T substantially forms the damper mass arrangement Ti. In this case also, a deactivation of the mass damper arrangement 28 is achieved owing to the positioning of the springs 74 comparatively far radially outward while utilizing the friction effect which increases in rotational operation as a result of centrifugal force and at higher rotational speed.

FIG. 49 shows an embodiment of the torque transmission assembly 10 similar to that in FIG. 48. In this case, the mass part 74 which is arranged at the radially central region of the coupling element 66 is provided by a plurality of disks, for example, arcuate or annular sheet metal segments, disposed successively in axial direction. These disks are formed with teeth in their outer circumferential region and engage in a rotationally coupling manner with a carrier 80 formed angularly at and fastened, e.g., riveted, to the coupling element 66. The axial connection is formed by a retaining ring fastened to the axially extending portion. This mass part 74 formed with a plurality of disks is comparatively inexpensive to produce and, with respect to its total mass, can be varied to adapt to the required damping characteristic.

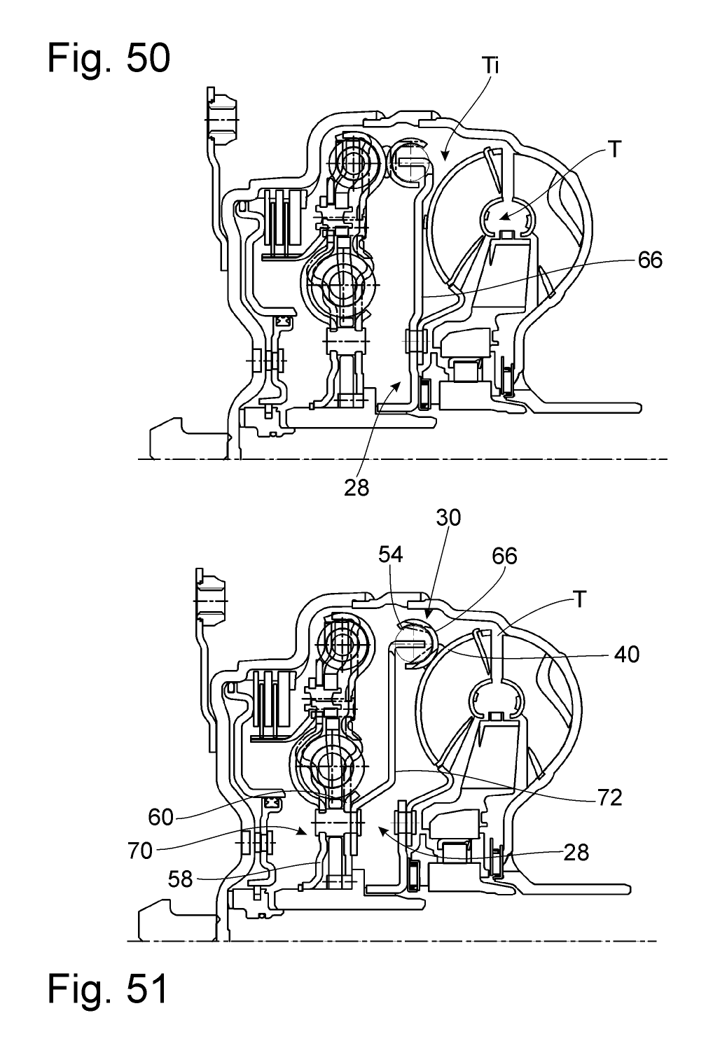

FIG. 50 shows an embodiment which corresponds substantially to that shown in FIGS. 48 and 49. In this case, however, no additional mass part is provided at the coupling element 66. The damper mass arrangement Ti is substantially provided by the turbine T and coupling element 66.

FIG. 51 shows an embodiments in which the coupling element 66 connected to the turbine T extends around the circumference of the springs 64 of the mass damper elastic arrangement 30. The coupling element 66 can be fastened to the turbine shell 40, e.g., by welding. The coupling element 72 connected to the intermediate mass arrangement 70 engages radially outwardly with the springs 64 so as to support them circumferentially and extends radially inward and is fixedly connected in its radially inner region to the two cover disk elements 58, 60 by riveting. With the springs 64 of the mass damper elastic arrangement 30 also arranged comparatively far radially outward, the connection of the coupling element 72 can be carried out by welding, which is advantageous when the coupling element 72 and cover disk elements 58, 60 are formed as nitrided plates.

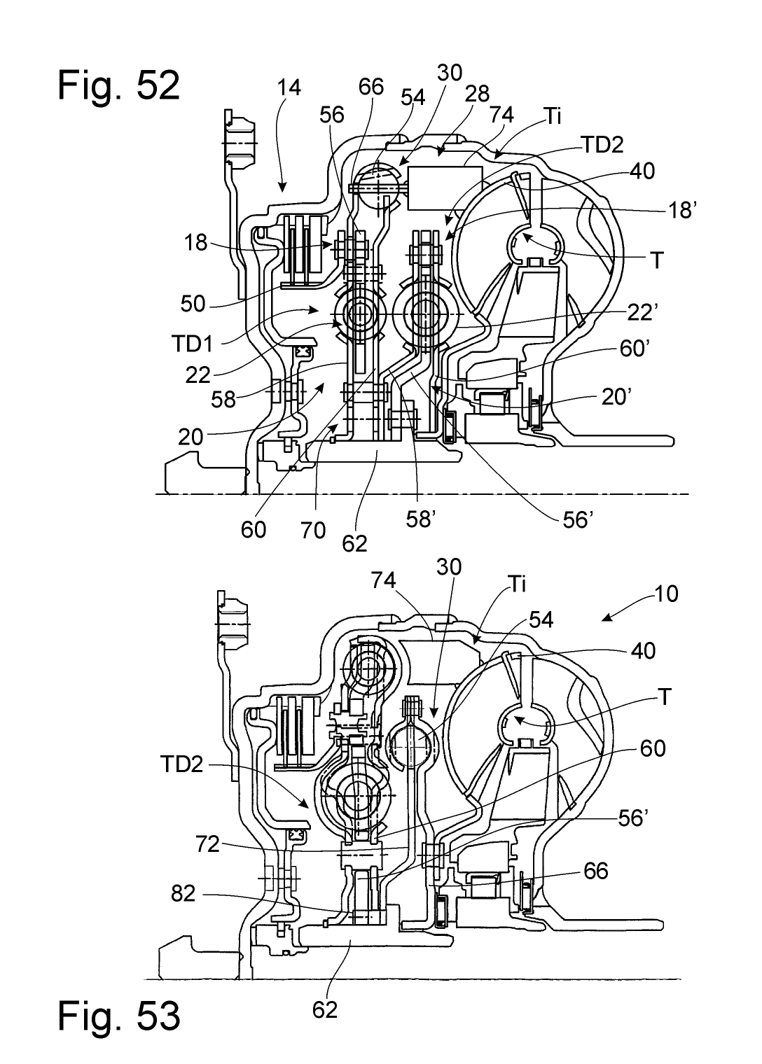

FIG. 52 shows an embodiment in which the two torsional vibration damper units TD1 and TD2 are not radially staggered but are arranged axially successively. The inner disk carrier 50 of the lockup clutch 14 is fixedly connected, e.g., riveted, to the central disk element 56, i.e., to the primary side 18 of the torsional vibration damper unit TD1 which is positioned closer axially to the lockup clutch 14. The two cover disk elements 58, 60 of the torsional vibration damper unit TD1 are fixedly connected to one another radially inwardly by riveting. A cover disk element 58′ of the torsional vibration damper unit TD2 is also connected to the two cover disk elements 58, 60 of the torsional vibration damper unit TD1 in the region of this riveted connection. The two cover disk elements 58′ and 60′ of the torsional vibration damper unit TD2 are fixedly connected to one another by riveting on the radially outer side, i.e., radially outside of the damper spring arrangement 22′. While the two cover disk elements 58, 60 of torsional vibration damper unit TD1 form the secondary side 20 thereof, the two cover disk elements 58′, 60′ provide the primary side 18′ of torsional vibration damper unit TD2. The central disk element 56′ then substantially forms the secondary side 20′ of torsional vibration damper unit TD2 which is connected to the driven hub 62 by riveting. It will be seen that the two damper spring arrangements 2 and 22′ in this embodiment are situated approximately on the same radial level.

For the connection of the mass damper arrangement 28, the two cover disk elements 58, 60, which together with the cover disk elements 58′, 60′ substantially also provide the intermediate mass arrangement, are lengthened radially outwardly, where they form circumferential supporting regions for the springs 64 of the mass damper elastic arrangement 30. The damper mass arrangement Ti substantially includes one or more mass parts 74 which is/are connected to the turbine shell 40 of the turbine T. One or more coupling elements 66 extend(s) in the other axial direction proceeding from the mass part 74 or mass parts 74 for the circumferentially supporting engagement with the springs 64. Together with the turbine T, the mass part or mass parts 74 substantially provide the damper mass arrangement Ti. Since the structural component parts substantially contributing to the mass of the damper mass arrangement Ti and also the mass damper elastic arrangement 30 are arranged far radially outward, an excellent damping potential is achieved in this case; the fact that the mass part 74 extends directly up to the turbine shell 40 and is connected to the latter by welding also contributes to this excellent damping potential. Through the positioning of the springs 64 of the mass damper elastic arrangement 30, it is also ensured at the same time that the frictional interaction thereof, in this case particularly with the radially outwardly lengthened cover disk element 58, varies as a function of rotational speed so that the efficiency of the mass damper arrangement 28 decreases with increasing speed.

Another variation of the torque transmission assembly 10 according to the invention is shown schematically in FIG. 18. In this embodiment, the damper mass arrangement Ti and turbine T contributing to the latter are coupled via the mass damper elastic arrangement 30 to the output region 26 of the torsional vibration damper arrangement 16 and therefore to the secondary side 20′ of the torsional vibration damper unit TD2. In this case, the damper mass arrangement Ti is situated together with the turbine T directly in front of the transmission input shaft GEW. Apart from the advantage of a small additional space requirement, the assemblies provided for increasing the damper mass and the turbine T also cooperate in this instance to form a comparatively large total mass of the damper mass arrangement Ti and correspondingly also of the secondary side of the torsional vibration damper unit TD2. This arrangement is particularly suited to drivetrains with a comparatively stiff transmission input shaft.

FIG. 53 shows a constructional variant thereof. With respect to construction, this variant substantially corresponds to the variant already described above with reference to FIG. 46. In contrast to the latter, however, the coupling element 72 cooperating radially outwardly with the springs 64 of the mass damper elastic arrangement 30 is located farther radially inward and, in its radially inner region, engages in a rotationally coupling manner with the driven hub 62. This driven hub 62 can have at its outer circumferential region teeth 82 which are engaged in a rotationally coupling manner by inner circumferential teeth at the central disk element 56′ of the radially inner torsional vibration damper unit TD2 on the one hand and by corresponding inner circumferential teeth at the coupling element 72 on the other hand. The cover disk element 60 can also mesh with these teeth 82, but with circumferential movement play, so as to define a maximum deflection angle of the second torsional vibration damper unit TD2. The mass part or the plurality of mass parts 74 is or are connected by welding to the turbine shell 40 of turbine T radially outside of the mass damper elastic arrangement 30 so that the installation space available radially outward of the springs 54 contributes very efficiently to providing the largest possible total mass of the damper mass arrangement Ti. The radial centering of the turbine T is carried out in this case by the coupling element 66 which is radially and, if necessary, also axially supported at the outer circumference of the driven hub 62.

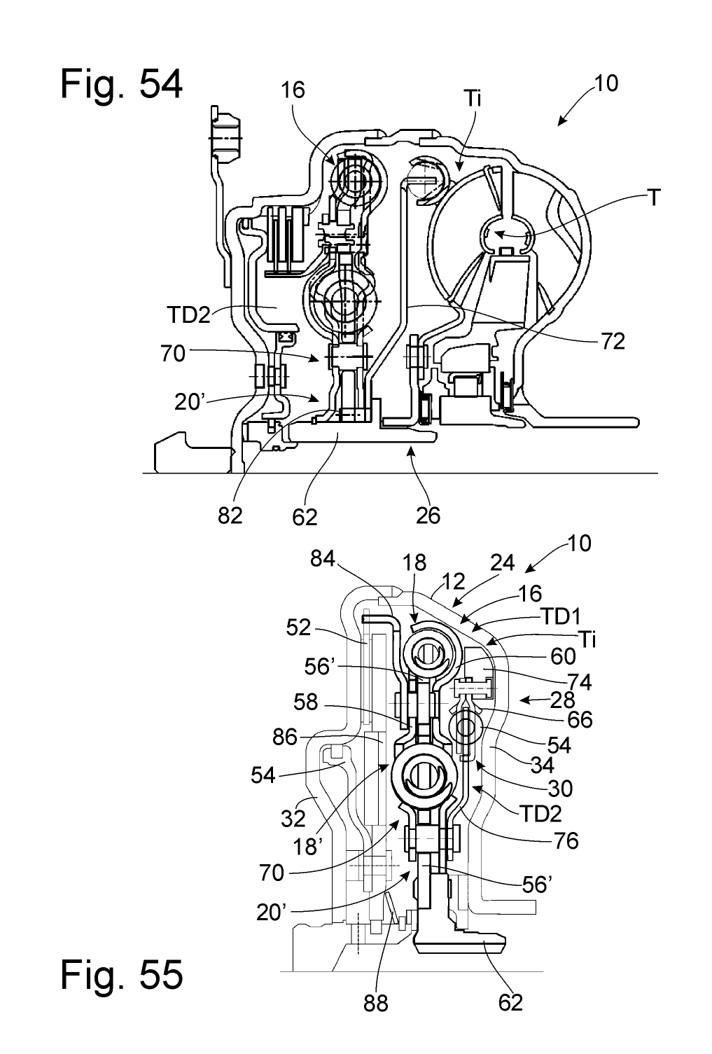

The embodiment of the torque transmission assembly 10 shown in FIG. 54 substantially corresponds to that already described above referring to FIG. 51. The coupling element 72 used for coupling to the intermediate mass arrangement 70 is drawn farther radially outward in this case and engages in a rotationally coupling manner with teeth 82 at the driven hub 62. Accordingly, in this case also, the damper mass arrangement Ti comprising the turbine T is coupled to the secondary side 20′ of the second, or radially inner, torsional vibration damper unit TD2 and to the output region 26 of the torsional vibration damper arrangement 16, respectively.

The radial centering of the turbine T is carried out in this case by a region thereof which is drawn radially inward to the driven hub 62 and which may be constructed as a separate structural component part and is radially and possibly also axially supported on the driven hub 62.

The embodiment of a torque transmission assembly in the form of a wet clutch is described with reference to FIG. 55. This embodiment comprises a housing 12 with two housing shells 32, 34 a torsional vibration damper arrangement 16 having two torsional vibration damper units TD1 and TD2. An outer disk carrier 84 is fixedly connected to the two cover disk elements 58, 60 by riveting. In the radially outer region, these two cover disk elements 58, 60 substantially form the primary side of the torsional vibration damper unit TD1 as well as the input region 24 of the torsional vibration damper arrangement 16. In their radially inner region, they substantially form the primary side 18′ of the radially inner torsional vibration damper unit TD2. The secondary side 20′ thereof substantially comprises the central disk element 56′ which is fastened to the driven hub 62 by riveting.

The outer disk carrier 84 is coupled with a friction element or disk 52 so as to be fixed with respect to rotation relative to it. This friction element or disk 52 can be clamped axially between the housing shell 32 and a pressing element 86 for producing the engaged state. By means of a clutch piston 54 which together with the pressing element 86 divides the interior of the housing 12 into two volume regions, it is possible through frictional interaction of varying degree to achieve an engaged state, a disengaged state or a slip state by adjusting the pressure ratios and by utilizing the pre-loading force of a pre-loading spring 88.

The mass damper arrangement 28 is fixedly connected to the intermediate mass arrangement 70 by the rivet bolts fixedly connecting the two cover disk elements 58, 60 on the radially inner side. A coupling element 72 is used for this purpose. This coupling element 72 projects radially outward and provides circumferential supporting regions in its radially outer region for the springs 54 of the mass damper elastic arrangement 30. A coupling element 66 having two cover disk elements is fixedly connected, e.g., riveted, radially outwardly to an annular mass part 74 or a plurality of mass parts 74 arranged successively in circumferential direction and together with the latter substantially provides the damper mass arrangement Ti of the mass damper arrangement 28.

The constructional variants shown above referring to use in hydrodynamic torque converters and with respect to both construction and positioning, e.g., of the torsional vibration damper arrangement, the torsional vibration damper units thereof and the mass damper arrangement can also be applied in a wet clutch of this kind. All of these constructional principles or constructional embodiments can also be transferred to and used in fluid couplings.

FIG. 19 shows the use of a mass damper arrangement 28, constructed as a fixed-frequency damper, with a damper mass arrangement Ti and mass damper elastic arrangement 30 in a torque transmission assembly 10 in which a torsional vibration damper arrangement 16 is provided with three torsional vibration damper units TD1, TD2 and TD working in series. In this case also, for example, use in a hydrodynamic torque converter, a fluid coupling and a wet clutch can again be realized.

The primary side 18 of the first torsional vibration damper unit TD1 also substantially provides the input region 24 of the torsional vibration damper arrangement 16 and adjoins the lockup clutch 14. The secondary side 20 of this first torsional vibration damper unit TD1 adjoins the primary side 18′ of the second torsional vibration damper unit TD2 and together with the latter forms an intermediate mass arrangement 60. The secondary side 20′ of the second torsional vibration damper unit TD2 adjoins a primary side 18″ of a third torsional vibration damper unit TD3 and together with the latter forms another intermediate mass arrangement 70′. The primary side 18″ of the third torsional vibration damper unit TD3 is coupled in a torque-transmitting manner via a damper spring arrangement 22″ with a secondary side 20″ of the third torsional vibration damper unit TD3. This secondary side 20″ substantially provides the output region 26 of the torsional vibration damper arrangement 16 and is coupled to the transmission input shaft GEW.

In the embodiment of FIG. 19, it will be seen that the turbine T is coupled to the intermediate mass arrangement 70′ between the two torsional vibration damper units TD2 and TD3. The mass damper arrangement 28 is also coupled to this intermediate mass arrangement 70′ either directly or via the turbine T.

This embodiment is particularly advantageous because an excellent damping potential is provided owing to the connection of the mass damper arrangement 28 between the second torsional vibration damper unit TD2 and third torsional vibration damper unit TD3, and further two torsional vibration damper units TD1 and TD2 are also connected upstream of the turbine T and mass damper arrangement 28, respectively.

In the embodiment shown in FIG. 20 with three torsional vibration damper units TD1, TD2 and TD3, the mass damper arrangement 28 is coupled to the input region 24 of the torsional vibration damper arrangement 16 and accordingly to the primary side 18 of the first torsional vibration damper unit TD1, i.e., directly downstream of the lockup clutch 14, with the turbine T coupled between the two torsional vibration damper units TD2 and TD3.

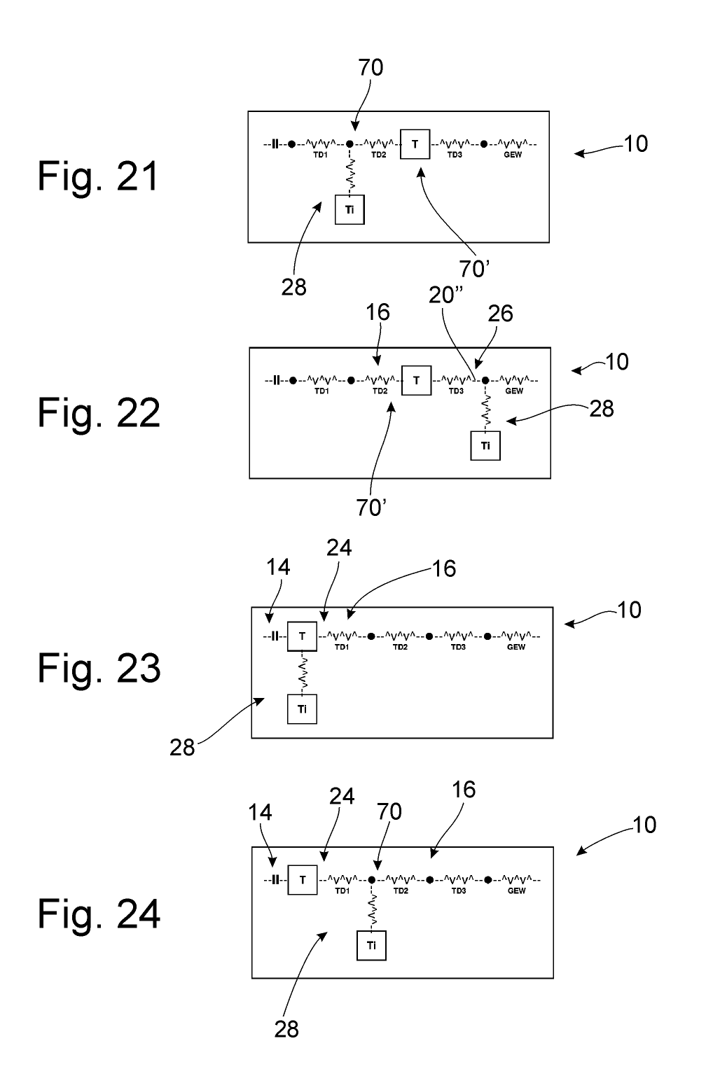

FIG. 21 shows an embodiment in which the mass damper arrangement 28 is coupled to the intermediate mass arrangement 70 between the two torsional vibration damper units TD1 and TD2, while the turbine T is coupled to the intermediate mass arrangement 70′ between the two torsional vibration damper units TD2 and TD3.

In the embodiment shown in FIG. 22, the turbine T is coupled between the two torsional vibration damper units TD2 and TD3, i.e., to the intermediate mass arrangement 70′. The mass damper arrangement 28 is coupled to the output region 26 of the torsional vibration damper arrangement 16 and therefore to the secondary side 20″ of the third torsional vibration damper unit TD3 and is accordingly located in terms of effect directly in front of the coupling to the transmission input shaft GEW.

FIG. 23 shows an embodiment in which the turbine T is located in the torque flow—with respect to the drive condition—downstream of the lockup clutch 14 and upstream of the first torsional vibration damper unit TD1 of the torsional vibration damper arrangement 16 and is therefore coupled to the input region 24 thereof. The mass damper arrangement 28 is likewise coupled to this input region 24 either directly or via the turbine T.

In the embodiment shown in FIG. 24, the mass damper arrangement 28 is coupled to the intermediate mass arrangement 70 between the two torsional vibration damper units TD1 and TD2. The turbine is coupled to the input region 24 of the torsional vibration damper arrangement 16.

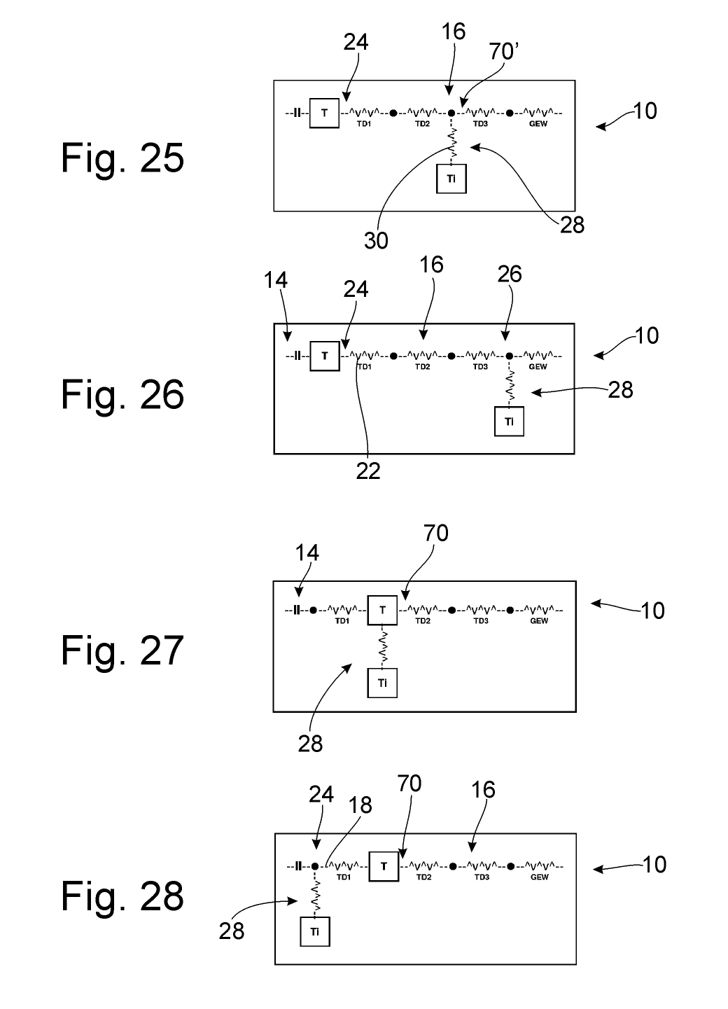

FIG. 25 shows an embodiment in which the turbine T is coupled to the input region 24 of the torsional vibration damper arrangement 16, while the mass damper arrangement 28 is coupled via its mass damper elastic arrangement 30 to the intermediate mass arrangement 70′ between the second torsional vibration damper unit and the third torsional vibration damper unit TD3.

In FIG. 26, the mass damper arrangement 28 is coupled to the output region 26 of the torsional vibration damper arrangement 16, while the turbine T is coupled to the input region 24, i.e., between the lockup clutch 14 and the first torsional vibration damper unit TD1 or damper spring arrangement 22 thereof. There is also a very good damping potential in this case owing to the three torsional vibration damper units TD1, TD2 and TD3 connected upstream of the mass damper arrangement 28.

In FIG. 27, the turbine T is coupled to the intermediate mass arrangement 70 between the first torsional vibration damper unit TD 1 and the second torsional vibration damper unit TD2 and therefore contributes to the increased mass. The mass damper arrangement 28 together with the turbine T or via the turbine T is coupled to the same intermediate mass arrangement 70.

In the embodiment shown in FIG. 28, the mass damper arrangement 28 is coupled to the input region 24 of the torsional vibration damper arrangement 16 or primary side 18 of the first torsional vibration damper unit TD1. The turbine T is coupled to the intermediate mass arrangement 70 between the first torsional vibration damper unit TD1 and the second torsional vibration damper unit TD2.

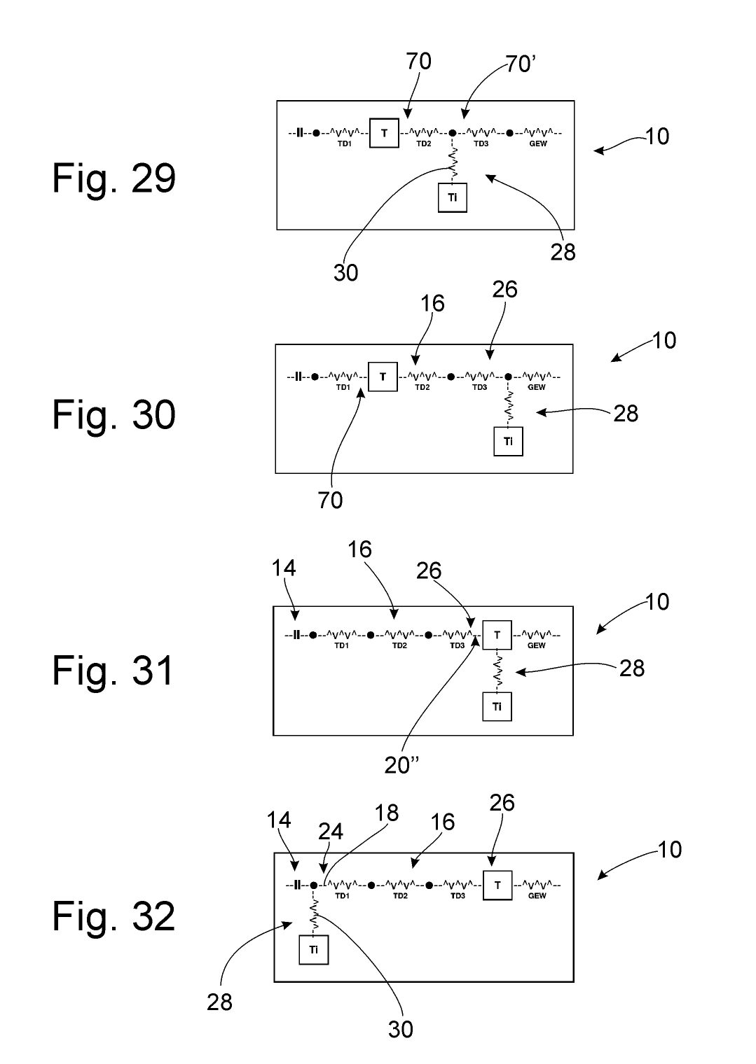

In FIG. 29, the mass damper arrangement 28 is coupled to the intermediate mass arrangement 70 between the second torsional vibration damper unit TD2 and the third torsional vibration damper unit TD3, while the turbine T is connected to the intermediate mass arrangement 70 between the first torsional vibration damper unit TD1 and the second torsional vibration damper unit TD2. Accordingly, in this case also, no mass damper arrangement is coupled to the intermediate mass arrangement 70 to which the turbine T is coupled.

FIG. 30 shows an embodiment in which the mass damper arrangement 28 is coupled directly upstream of the connection to the transmission input shaft GEW, i.e., to the output region 26 of the torsional vibration damper arrangement 16. The turbine T is coupled to the intermediate mass arrangement 70 between the first torsional vibration damper unit TD 1 and the second torsional vibration damper unit TD2.

FIG. 31 shows an embodiment in which the turbine T, and the mass damper arrangement 28 along with it, is coupled to the output region 26 of the torsional vibration damper arrangement 16, i.e., the secondary side 20″ of the third torsional vibration damper unit TD3.

FIG. 32 shows an embodiment in which the mass damper arrangement 28 with its mass damper elastic arrangement 30 is coupled to the input region 24 of the torsional vibration damper arrangement 16, i.e., the primary side 18 of the first torsional vibration damper unit TD 1 and, therefore, directly downstream of the lockup clutch 14. Turbine T is coupled to the output region 26 for an area directly in front of the connection to the transmission input shaft GEW.

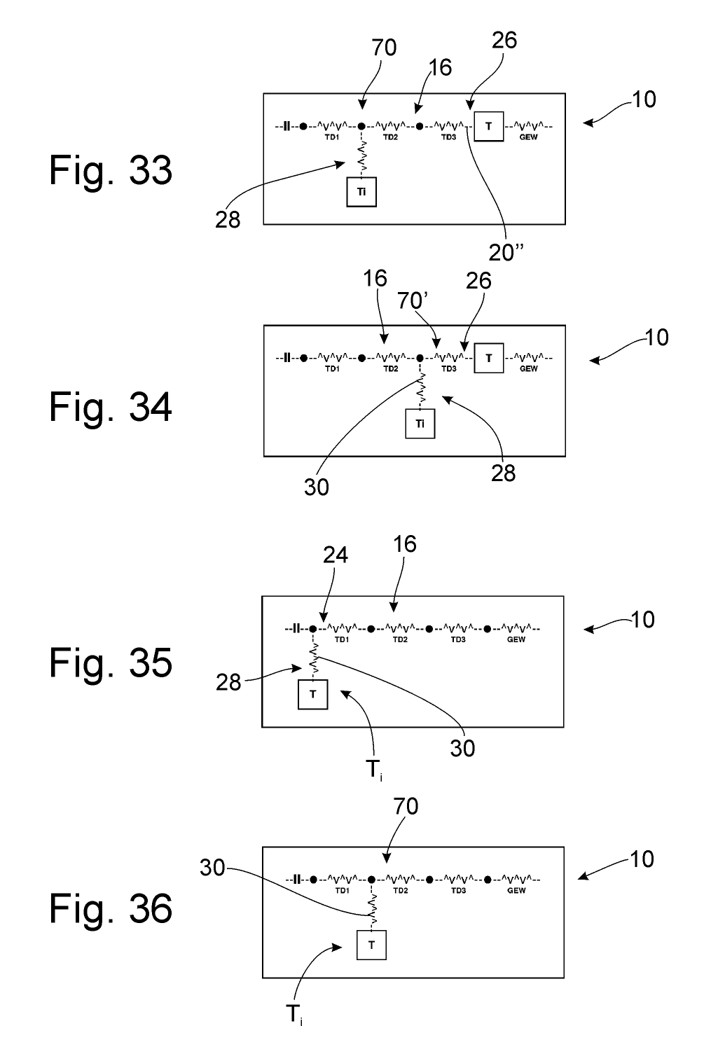

In the embodiment shown in FIG. 33, the mass damper arrangement 28 is connected to the intermediate mass arrangement 70 between the two torsional vibration damper units TD1 and TD2. Turbine T is coupled to the output region 26 of the torsional vibration damper arrangement 16 and, therefore, the secondary side 20″ of the third torsional vibration damper unit TD3.

In the embodiment shown in FIG. 34, the mass damper arrangement 28 together with the mass damper elastic arrangement 30 thereof and the damper mass arrangement Ti is coupled to the intermediate mass arrangement 70′ between the second torsional vibration damper unit TD2 and the third torsional vibration damper unit TD3, while the turbine T is coupled to the output region 26 of the torsional vibration damper arrangement 16.

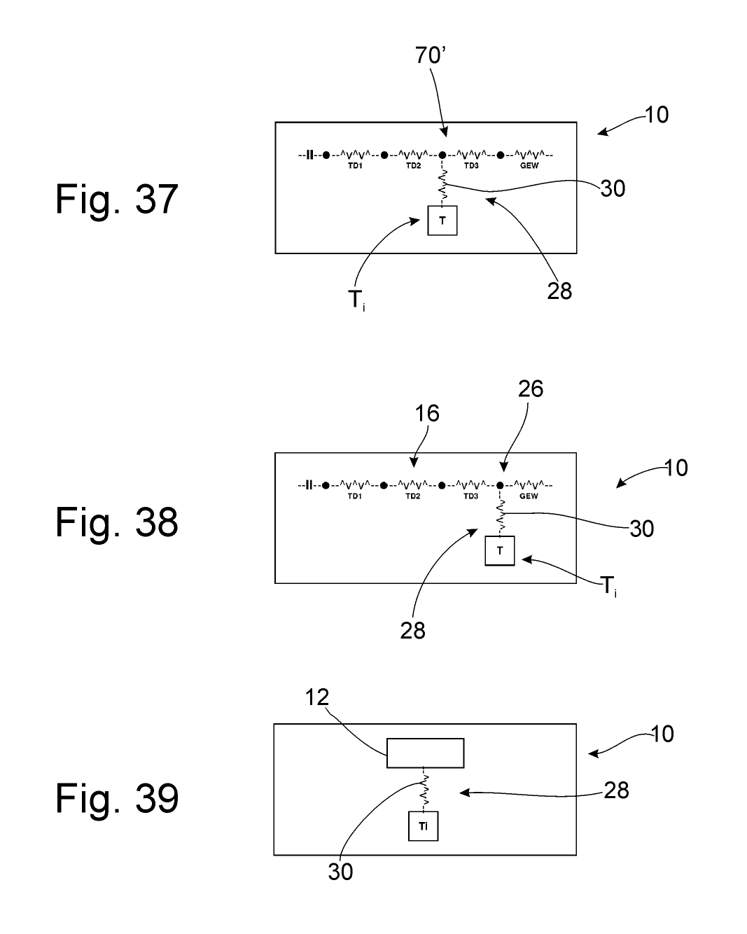

FIGS. 35 to 38 show embodiments of a torque transmission assembly 10, for example, in the form of a hydrodynamic torque converter, a fluid coupling or a wet clutch, in which the turbine T provides the basic component part of the damper mass arrangement Ti in a manner similar to that described, for example, with reference to FIG. 54. This means that there are no additional mass parts substantially contributing to the increased mass of the damper mass arrangement Ti. In this case it will be seen that, depending on the configuration, the mass damper arrangement 28 constructed in this way can be coupled to the input region 24 of the torsional vibration damper arrangement 16, with the intermediate mass arrangement 70 between the first torsional vibration damper unit TD 1 and the second torsional vibration damper unit TD2, the intermediate mass arrangement 70′ between the second torsional vibration damper unit TD2 and the third torsional vibration damper unit TD3 or the output region 26 of the torsional vibration damper arrangement 26, i.e., directly preceding the transmission input shaft GEW.

Another embodiment is illustrated in FIG. 39 which shows the torque transmission assembly, including housing 12, provided, for example, in the form of a fluid coupling, a hydrodynamic torque converter or a wet clutch. The different assemblies described above, e.g., a lockup clutch and the torsional vibration damper arrangement, are provided in this housing 12. It is to be noted that in this case, of course, the torsional vibration damper arrangement can be constructed with one, two or more torsional vibration damper units and/or a fixed-frequency damper as was described above. The mass damper arrangement 28 is arranged outside of the housing 12 and is connected to the latter by its mass damper elastic arrangement 30. A substantial advantage in this embodiment consists in that it does not require additional installation space inside the housing 12 and, in particular, the mass damper elastic arrangement 30 is not exposed to the comparatively corrosive environment produced by a fluid, e.g., oil, at high temperature. Further, in this arrangement the configuration or coupling of the mass damper arrangement 28 is completely independent from the assemblies provided in the interior of the housing 12. In particular, it is not absolutely necessary that a torsional vibration damper arrangement be provided in the housing 12, i.e., for example, in the torque transmission path between a lockup clutch and a driven hub or a turbine and the lockup clutch or driven hub.

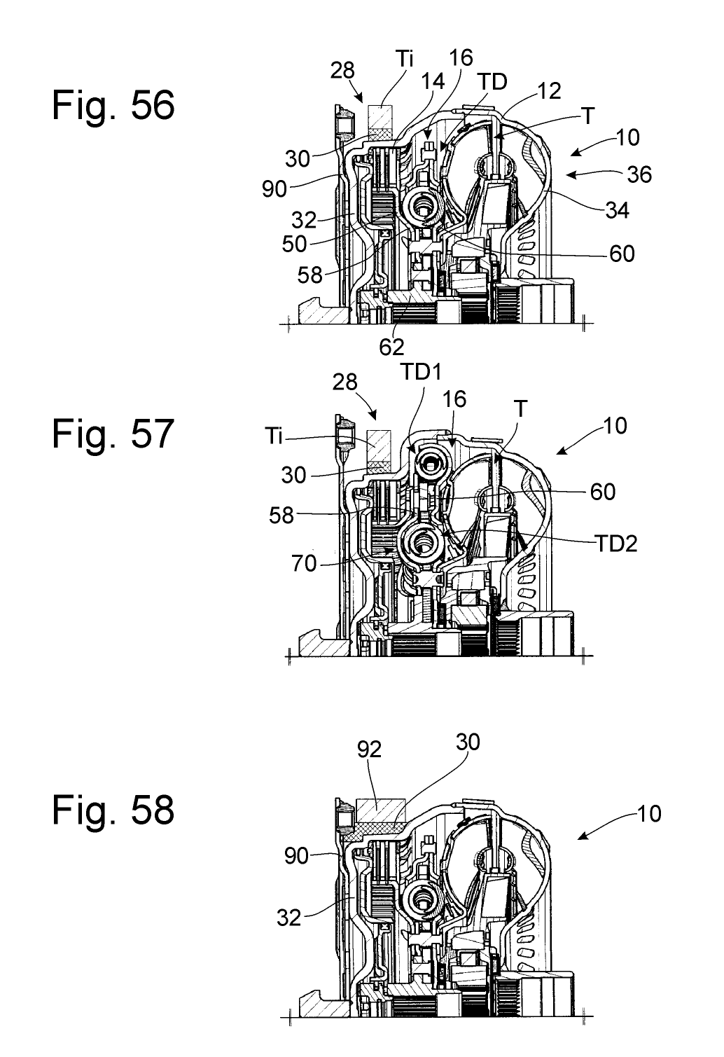

FIG. 56 shows a construction of a torque transmission assembly 10 of this kind in the form of a hydrodynamic torque converter. Shown within the housing 12 of the lockup clutch 14 is the torsional vibration damper unit TD of the torsional vibration damper arrangement 16, which torsional vibration damper unit TD is coupled to the lockup clutch 14 by the inner disk carrier 50; its input region, which is provided in this instance by two cover disk elements 58, 60, also carries the turbine T. Accordingly, a torsional vibration damper arrangement 16 shown here acts in the torque transmission path between the lockup clutch 14 and the turbine T and driven hub 62.

The mass damper arrangement 28 comprises a damper mass arrangement Ti which is constructed annularly or with annular segments and which is connected to the housing 12 at an outer circumferential region of the drive-side housing shell 32 of the housing 12 via the mass damper elastic arrangement 30. The mass damper elastic arrangement is preferably provided in this instance as an annular elastomer element which is fixedly connected in its outer circumferential region to the damper mass arrangement Ti in an extrinsically bonding manner, for example, by gluing or vulcanizing, and engages in a rotationally coupling manner with the outer circumference of the housing shell 32, for example, by teeth formed therein. In particular, these teeth can also serve to couple the friction elements of the lockup clutch 14, which are connected to the housing 12 so as to be fixed with respect to rotation relative to it, to the lockup clutch 14 so that the teeth which are formed by deformation of the housing shell 32 can be used at the inner side and also at the outer side of the housing shell 32.

Due to the deformability of the mass damper elastic arrangement 30, the damper mass arrangement Ti can move so as to oscillate in circumferential direction with respect to the housing 12 when vibratory excitations occur.

A particular advantage of this embodiment consists in that the elastomer material used as mass damper elastic arrangement 30, e.g., rubber or a rubber-like material, has a stiffness that is substantially independent from the temperature in the interior of the housing 12. It also possesses a stability such that it can be stably coupled to the housing 12 by the toothed engagement described above retentively over the life of operation. Alternatively or in addition, an extrinsically bonding connection, e.g., by means of gluing or vulcanizing, is also possible at the radially inner region of the mass damper elastic arrangement 30.

FIG. 57 shows an embodiment which basically corresponds to that described above with reference to FIG. 56. It will be seen that the torsional vibration damper arrangement 16 in this variant is formed with the two radially staggered torsional vibration damper units TD 1 and TD2 whose construction and integration into a torque transmission assembly, e.g., a hydrodynamic torque converter, was described at length above. The turbine T in this case is connected to the intermediate mass arrangement 70 provided by the two cover disk elements 58, 60.

FIG. 58 shows a modification of the embodiment shown in FIG. 56. In this case, alternatively or in addition to the rotational coupling of the mass damper arrangement 28 by means of toothed engagement of the mass damper elastic arrangement 30 with the housing shell 32, it will be seen that the mass damper elastic arrangement 30 is clamped axially between, e.g., a stepped shoulder of the housing shell 32 and a disk element 90 which serves to connect to a driveshaft and which is connected to the housing shell 32. Nuts 92 provided at this disk element 90 can also overlap at the same time to secure the mass damper elastic arrangement 30 radially from the outer side.

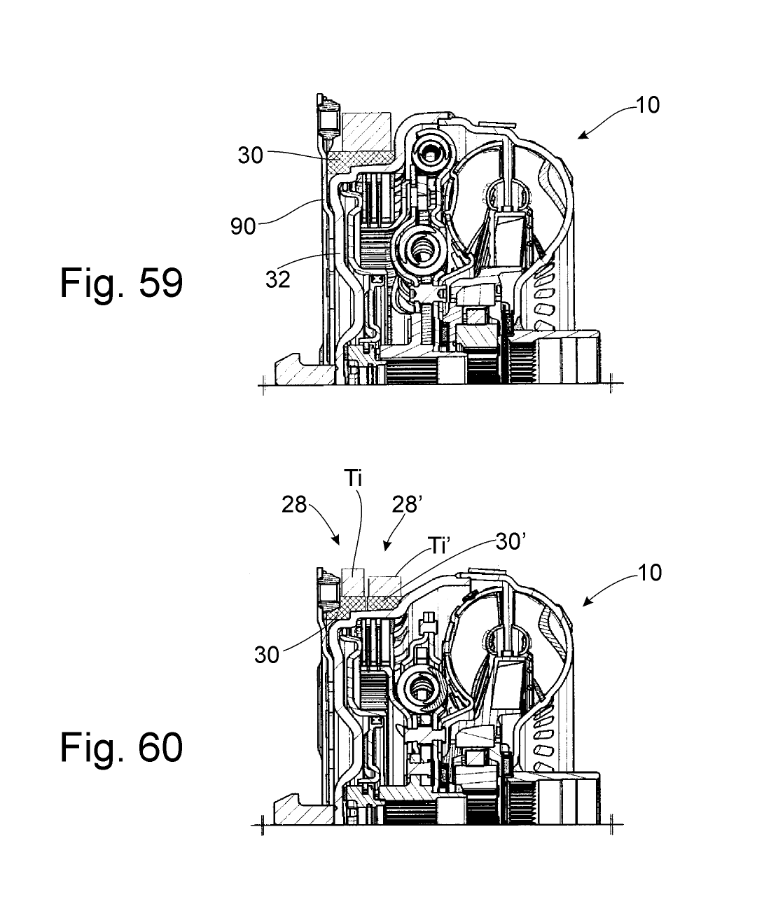

FIG. 59 shows a corresponding modification of the embodiment shown in FIG. 57. In this case also, the mass damper elastic arrangement 30 is clamped axially between the housing shell 32 and the disk element 90 alternatively or in addition to the toothed connection and/or extrinsically bonding connection by means of gluing or vulcanizing.

FIG. 60 shows a combination of the two embodiments shown above, referring to FIGS. 56 and 58, for the connection and construction of the mass damper arrangement 28. In particular, two mass damper arrangements 28 and 28′ are provided in this instance which are tuned, for example, to different natural frequencies or damping frequencies by corresponding selection of damper mass arrangements Ti and Ti′ and mass damper elastic arrangements 30 and 30′, respectively. Of course, this concept of combination can also be transferred to an embodiment of the torsional vibration damper arrangement having a plurality of torsional vibration damper units working in series.

The configuration which was described above referring to FIG. 39 and FIGS. 56 to 60, i.e., the positioning of one or more mass damper arrangements outside of the housing of the torque transmission assembly, combines different advantages. For one, there is no need to take into account a compatibility of the mass damper arrangement or components thereof with the medium, e.g., oil, in the housing or the comparatively high temperatures generally present in the interior of the housing, so that the performance characteristic of the mass damper arrangement is less dependent upon temperature. Further, these embodiments use an installation space that is generally not used for other components and they can be combined with other variants of vibration dampers or mass dampers without any structural problems. In particular, they can be combined in a modular manner with various other damper principles and with a variety of torque transmission assemblies. Further, it is easily possible to let mass damper arrangements work in parallel and to tune the latter to different natural frequencies.

It is to be noted that, of course, the embodiments described above, in which the mass damper arrangement is integrated in the housing and coupled therein, for example, to different areas of a torsional vibration damper arrangement, makes it possible to provide a plurality of mass damper arrangements working in parallel and to tune the latter with different natural frequencies, for example.

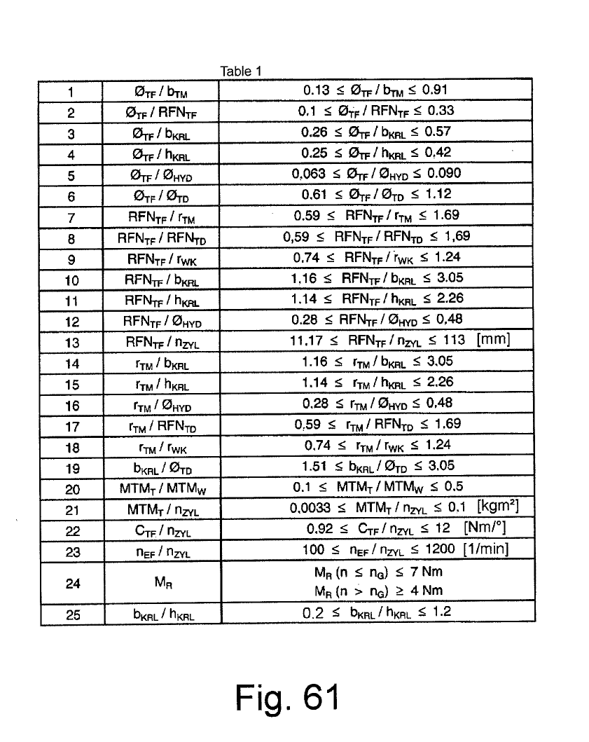

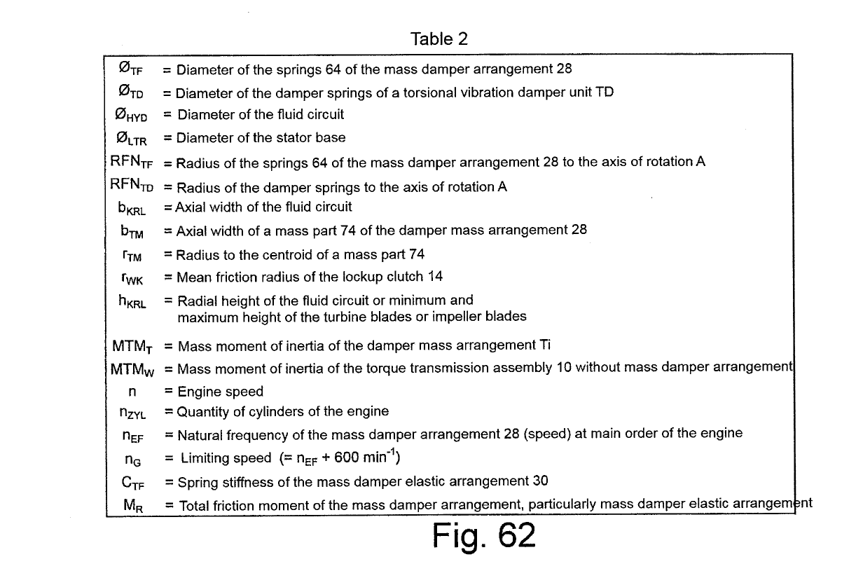

FIGS. 61 to 63 refer to various dimensions or dimensional relationships and values or value ranges which can be provided for these various embodiment forms of a torque transmission assembly constructed, for example, as hydrodynamic torque converter, fluid coupling or wet clutch, which were described above in connection with the present invention. It is to be noted that each of the values or value ranges indicated in lines 1 to 25 of Table 1 in FIG. 61 can be realized individually or in combination with any of the other values or value ranges in a torque transmission assembly according to the invention, particularly in the embodiment thereof which were described above.

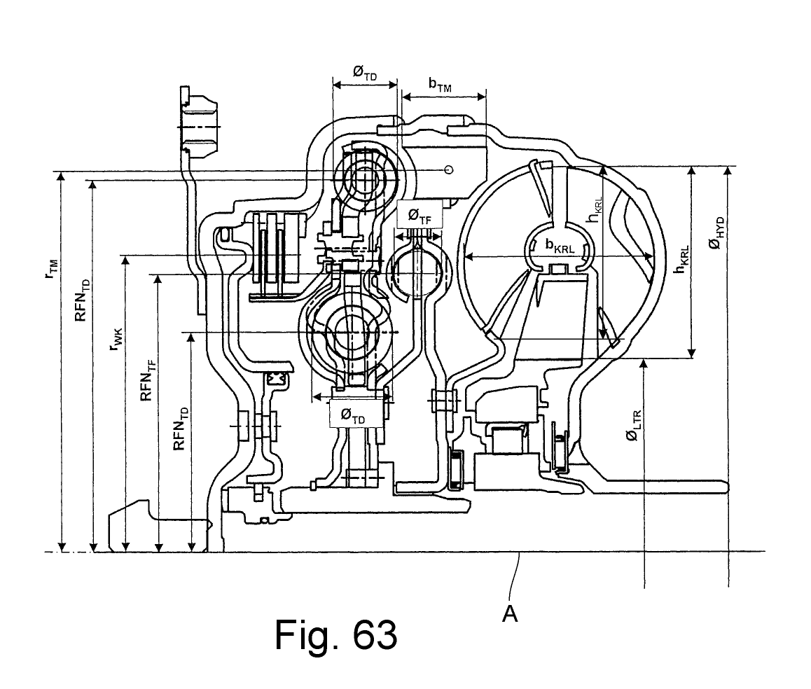

With respect to the quantities also shown in FIG. 63, it is to be noted that, for example, the respective radii and radial distances RFN_{TF} and RFN_{TD}, respectively, indicate the distance between the axis of rotation A of the torque transmission assembly 10 and, in each instance, the radial center region of the respective springs of the mass damper elastic arrangement or the respective damper spring arrangements. Since these springs generally extend in circumferential direction around the axis of rotation or tangentially thereto, this distance is measured in each instance relative to a longitudinal center axis or minimum distance thereof from the axis of rotation A.

With regard to the value range indicated in line 6 of Table 1 for the ratio of the diameter of the springs 64 of the mass damper elastic arrangement 28 to the diameter of the springs of a damper spring arrangement, it is to be noted that this ratio applies to each of a possible plurality of torsional vibration damper units TD of the torsional vibration damper arrangement. For example, in the embodiments example shown in FIG. 63 and in FIG. 44, this means that the indicated ratio of the diameter of the springs 64 of the mass damper elastic arrangement 30 to the diameter of the springs of the damper spring arrangement 22 of the radially outer torsional vibration damper unit TD1 and to the diameter of the springs of the damper spring arrangement 22′ of the radially inner second torsional vibration damper unit TD2 can lie within the indicated value range between 0.61 and 1.12.

With regard to the natural frequency n_{EF} of a mass damper arrangement 28 included by way of example in line 23 of Table 1, it is to be noted that, particularly when put in a ratio to the quantity n_{ZYL} of cylinders of an internal combustion engine or when used for determining a limiting rotational speed, this natural frequency can be expressed in 1/min in order to provide a ratio to the rotational speed of the internal combustion engine which is generally likewise indicated in 1/min or revolutions/min. For this purpose, it can be assumed, for example, that four ignitions take place in a four-cylinder four-cycle internal combustion engine per two revolutions. This means that two excitation events occur per revolution with the result that, for example, at a natural frequency of the mass damper arrangement 28 of 2000 RPM, a speed of the internal combustion engine of 1000 RPM can lead to an excitation of the mass damper arrangement in the range of its natural frequency.

With regard to the total friction moment, designated by M_{R}, of the mass damper arrangement 28 it is to be noted that this total friction moment takes into account primarily Coulomb friction effects which are generated, for example, in that the springs 64 of the mass damper elastic arrangement 30 as a result of centrifugal force make contact radially outwardly against the structural component parts supporting the latter, i.e., for example, coupling element 72 and/or 66, and, under compression, move along one or both of these structural component parts in a slidingly frictional manner. However, internal friction effects brought about by the displacement of fluid in the interior of the housing 12 of the torque transmission assembly 10 are not taken into account.

The spring stiffness C of the mass damper elastic arrangement 30 refers to the total elasticity or spring constant supplied by the mass damper elastic arrangement 30, i.e., as the case may be, the total spring constant of a plurality of springs or elastomer elements working in parallel and/or in series with one another.

The radius r_{TM} to the centroid of a mass part 74 of the damper mass arrangement Ti refers to a quantity which corresponds in principle to a mass centroid, but with respect to only a cross-sectional area of the mass part 74 and not to the total mass part 74. In this respect, it is to be taken into consideration that the mass part 74 generally extends annularly around the axis of rotation A so that the total mass centroid of a mass part of this kind or, as the case may be, of a plurality of mass parts 74 disposed successively in circumferential direction will lie on the axis of rotation A to prevent imbalances.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-26. (canceled)

27. A torque transmission assembly, comprising:
a housing arrangement;
a torsional vibration damper arrangement within the housing arrangement, wherein the torsional vibration damper arrangement includes:
an input region coupled to the housing arrangement,
and
an output region for coupling to a driven member; and
at least one mass damper arrangement having a damper mass arrangement which is coupled to the torque transmission assembly through a mass damper elastic arrangement.

28. The torque transmission assembly according to claim 27, wherein the mass damper elastic arrangement comprises an elastomer material arrangement.

29. The torque transmission assembly according to claim 27, wherein the mass damper elastic arrangement comprises a spring arrangement.

30. The torque transmission assembly according to claim 29, wherein the spring arrangement includes a helical spring arrangement.

31. The torque transmission assembly according to claim 27, wherein the at least one mass damper arrangement is coupled to the housing arrangement.

32. The torque transmission assembly according to claim 27, wherein the at least one mass damper arrangement is coupled to the torsional vibration damper arrangement.

33. The torque transmission assembly according to claim 32, wherein the at least one mass damper arrangement is coupled to the input region of the torsional vibration damper arrangement.

34. The torque transmission assembly according to claim 32, wherein the at least one mass damper arrangement is coupled to the output region of the torsional vibration damper arrangement.

35. The torque transmission assembly according to claim 27, wherein the torsional vibration damper arrangement comprises a torsional vibration damper unit having a primary side and a secondary side which is rotatable with respect to the primary side around an axis of rotation against an action of a damper spring arrangement, wherein the input region of the torsional vibration damper arrangement includes the primary side and the output region of the torsional vibration damper arrangement includes the secondary side.

36. The torque transmission assembly according to claim 27, wherein the torsional vibration damper arrangement comprises a plurality of torsional vibration damper units working in series, wherein each torsional vibration damper unit includes a primary side and a secondary side which is rotatable with respect to the primary side around an axis of rotation against an action of a damper spring arrangement, wherein the input region of the torsional vibration damper arrangement comprises the primary side of a first one of the plurality of torsional vibration damper units, wherein the output side of the torsional vibration damper arrangement comprises the secondary side of a last one of the plurality of torsional vibration damper units, and wherein a secondary side of a preceding torsional vibration damper unit of two successively arranged torsional vibration damper units and a primary side of a following torsional vibration damper unit of the two successively arranged torsional vibration damper units provide at least part of an intermediate mass arrangement.

37. The torque transmission assembly according to claim 36, wherein the at least one mass damper arrangement is coupled to the intermediate mass arrangement.

38. The torque transmission assembly according to claim 27, further comprising an impeller and a turbine arranged in the housing arrangement.

39. The torque transmission assembly according to claim 38, wherein the turbine provides at least part of the damper mass arrangement.

40. The torque transmission assembly according to claim 38, wherein the turbine is coupled to one of the input region and the output region of the torsional vibration damper arrangement.

41. The torque transmission assembly according to claim 38, wherein the turbine is coupled to an intermediate mass arrangement.

42. The torque transmission assembly according to claim 41, wherein the turbine and the at least one mass damper arrangement are coupled to the intermediate mass arrangement.

43. The torque transmission assembly according to claim 38, wherein the at least one mass damper arrangement is coupled to the turbine.

44. The torque transmission assembly according to claim 41, wherein no mass damper arrangement is at the intermediate mass arrangement to which the turbine is coupled.

45. The torque transmission assembly according to claim 27, wherein a ratio of a mass moment of inertia of the at least one mass damper arrangement of the damper mass arrangement, to a mass moment of inertia of the torque transmission assembly without the at least one mass damper arrangement is:
0.1≦MTM_{T}/MTM_{W}≦0.5.

46. The torque transmission assembly according to claim 27, wherein a friction moment of the at least one mass damper arrangement of the mass damper elastic arrangement is:
M_{R}(n≦n_{G})≦7 Nm
M_{R}(n>n_{G})≧4 Nm,
where n is a rotational speed of the torque transmission assembly around an axis of rotation, and wherein nG is a limiting rotational speed at a predetermined speed distance above a rotational speed corresponding to a natural frequency of the at least one mass damper arrangement.

47. The torque transmission assembly according to claim 38, wherein a ratio of an axial width of a fluid circuit formed with the turbine and the impeller to a radial height of a fluid circuit is:
0.2≦b_{KRL}/h_{KRL}≦1.2.

48. The torque transmission assembly according to claim 27, wherein a ratio of a diameter of springs of the mass damper elastic arrangement to their radial distance with respect to an axis of rotation (A) is:
0.1Ø_{TF}/RFN_{TF}≦0.33.

49. The torque transmission assembly according to claim 27, wherein a ratio of a radial distance of springs of the mass damper arrangement with respect to an axis of rotation to a radial distance of a centroid of a mass part of the damper mass arrangement with respect to the axis of rotation is:
0.59≦RFN_{TF}/r_{TM}≦1.69.

50. The torque transmission assembly according to claim 27, wherein the torque transmission assembly includes one of a hydrodynamic torque converter, a fluid coupling, and a wet clutch.

51. A drive system comprising a multi-cylinder internal combustion engine and a torque transmission assembly according to claim 27 which is coupled with a crankshaft of a multi-cylinder internal combustion engine.

52. The drive system according to claim 51, wherein a ratio of a mass moment of inertia of the at least one mass damper arrangement of the damper mass arrangement, to a quantity of cylinders of the multi-cylinder internal combustion engine is:
0.0033 kgm2≦MTM_{T}/n_{ZYL}≦0.1 kgm².

53. The drive system according to claim 51, wherein a ratio of a stiffness of the mass damper elastic arrangement to a quantity of cylinders of the multi-cylinder internal combustion engine is:
0.92 Nm/°≦C_{TF}/n_{ZYL}≦12 Nm/°.

54. The drive system according to claim 51, wherein a ratio of a rotational speed of the multi-cylinder internal combustion engine corresponding to a natural frequency of the at least one mass damper arrangement to a quantity of cylinders of the multi-cylinder internal combustion engine is:
100/min≦n_{EF}/n_{ZYL}≦1200/min.
